(19) United States
(12) Patent Application Publication
(10) Pub. No.: US 2008/0140696 A1
(43) Pub. Date: Jun. 12, 2008

(54) System and method for analyzing data sources to generate metadata

(75) Inventor: Janak Mathuria, Fairfax, VA (US)

Correspondence Address: ROTHWELL, FIGG, ERNST & MANBECK, P.C., 1425 K STREET, N.W., SUITE 800, WASHINGTON, DC, 20005, US

(73) Assignee: Pantheon Systems, Inc., Potomac, MD (US)

(21) Appl. No.: 11/634,902

(22) Filed: Dec. 7, 2006

(51) Int. Cl. G06F 17/30

(52) U.S. Cl. 707/102; 707/E17.044

(57) ABSTRACT

A system and method are provided for generating metadata relating to an enterprise management system including at least one data source having one or more of tables and columns. Constraints existing on at least one of the tables and columns in the data source are inferred based on data in the tables and columns. Metadata that includes information on the inferred constraints is generated.

### BACKGROUND OF THE INVENTION

1. Field of the Invention

The present invention relates generally to systems and methods for analyzing data sources to generate metadata, (i.e., data about the underlying data). More particularly, the present invention relates to systems and methods for generating metadata from disparate data sources by inferring data relationships and rules based on the data in the disparate data sources and/or query and procedure code.

2. Description of the Related Art

Databases are well known and are used to store and maintain information for almost every conceivable application. The use of databases has become increasingly prevalent over the last few decades; and, today, the vast majority of business records are maintained in databases.

For large businesses, database information can include thousands of different kinds of information and often will range from millions to billions of records. Such businesses seek to leverage their data to make quick, informed business decisions. Business Intelligence (BI) tools help companies make better business decisions by allowing access to relevant data, providing ways to perform in-depth analysis of the data, and presenting the results of the analysis in a manner that facilitates understanding and dissemination of the information contained in the data. The primary users of BI tools are business analysts, managers and decision makers.

A Database Management System (DBMS) is a computer software application that creates and manages databases according to the specific requirements of an individual database model. Exemplary well-known database models include the hierarchical, network, relational, object-oriented and object-relational database models. The relational model is currently the predominant database model and the corresponding database management system is known as a Relational Database Management System (RDBMS).

One of the most common operations performed on relational databases is called a “query,” which is a program construct that accesses the database to obtain a subset of the data of interest to the user. In relational databases, the data is often split across multiple tables. The declarative computer language used to query, access and manipulate data stored in relational databases is known as the Structured Query Language (SQL). However, most business analysts, managers and corporate decision makers are not knowledgeable of the SQL language and are also not familiar with the data model. “Data model” refers to the logical organization of application data in the database. As a result, the primary users of such BI tools are often unable to access the data directly. In addition, information technology staffs are often unable to successfully use SQL to retrieve the desired data because the user must have an intimate knowledge of the data model used to create the database in order to include the correct commands in a query to retrieve the required data from the tables.

Such problems are also commonly encountered with the use of commercial off-the-shelf products (COTS), as well as BI software applications that have been custom developed for an organization. In the instance of custom developed software, once the original designers have departed from the organization, it is frequently the case that no one remains with intimate knowledge of the data model used to create the custom software and often either associated documentation is missing or there is minimal informative documentation available for the customized software.

BI tool manufacturers face the challenge of enabling business users to query the data by hiding the complexities of SQL and allowing users to access information without an intimate knowledge of the underlying data model. Many BI tools do not directly query the relational database. Instead, the tools extract, transform and load (ETL) the relational data or a subset thereof into a multidimensional data warehouse or data mart. However, the ETL operation also requires an intimate knowledge of the data model.

BI tools that query the relational data directly usually rely upon a metadata layer, that is, data about the underlying data. The metadata layer contains information about the data model. The metadata layer approach is popular because it helps empower the end user to access data without having to deal with the technical intricacies. However, the construction of the metadata layer requires in depth knowledge of the data model.

RDBMS store some information about the database's data model in catalog tables. The catalog tables contain information about the tables, columns, rows and any expressly defined constraints and relationships. The catalog tables may be queried to reverse engineer some of the data model. This approach works well when the catalog tables contain complete information about the data model.

Catalog tables only contain information that is explicitly defined, such as tables, rows and columns. However, constraints need not be explicitly defined as part of the data model. There are many reasons why even constraints supported by the RDBMS may not be explicitly defined as part of the data model, including the following:
a. An organization may often develop enhancements on top of COTS or existing applications. Such enhancements require creation of new tables that are related to the existing tables. However, for security reasons, the creators of the new tables may not be granted privileges to create a referential integrity constraint on these existing tables. Hence such constraints are not explicitly defined.
b. Organizations often have multiple databases with possibly different underlying RDBMS vendors. Tables may be logically related across such databases. However, most RDBMS generally do not allow creation of referential integrity constraints across multiple database instances.
c. Most constraints such as the NOT NULL constraint, and referential integrity constraints are implemented at the source of the data itself. For example, such constraints are typically implemented at the data entry page (i.e., in the client interface, not the database) where the user may input these values. It is desirable to do so as the user can receive immediate feedback in the event of any erroneous input. If a constraint is enforced at all the sources of data, then defining it as part of the data model is not required. In most cases, it is still desirable to define a constraint as part of the data model. But often in such cases, to avoid the cost of implementing the constraint as part of the data model and also in order to have a thin database layer with a thicker application layer, the constraints may not be specified as part of the data model. This is often the case when the application designers and developers are not experts in database design.
d. Certain constraints are not implemented consistently across RDBMS vendors. For example, in ORACLE, the unique key constraint ignores rows where all the columns that constitute the unique key are NULL. Thus, if a unique key is defined for column x, the table can contain more than 1 row with column x set to NULL. In SQL Server, the unique key constraint does not ignore such rows. Thus, having more than 1 row with column x set to NULL will violate the unique key constraint in SQL Server. Thus, to maintain portability across database vendors or because the implemented semantics may not be ideally suited to the actual requirement, such constraints may not be explicitly defined as part of the data model, but rather are implemented instead at the sources of the data.
e. In the case of very large tables, explicit definition of referential integrity constraints may slow the insert, update or delete operations. Thus, it may be desirable to enforce the constraints outside the data model instead of defining it explicitly.
f. Most COTS packages have predefined data models that cannot be modified. Often their design makes allowance for extra columns that a customer may choose to use as needed. A customer may decide to store data in these columns and that data that may be related to data in another table or may have other constraints. The data model does not reflect such relationships or constraints.

As applications get larger and more complex and interface with a large number of other applications, the explicit data model defined in catalog tables becomes less sufficient to populate the metadata layer for a BI system. This is a commonly encountered problem during BI implementations. A large amount of time and effort is spent in obtaining a global view of the data model that is not necessarily available through the relational catalogs. The global view of the data model may be referred to as the enterprise data model. The enterprise data model can span across multiple data sources in an organization, including for example, multiple database instances with different underlying database models and/or vendor technologies, flat files, and other data stores. Any system used by an organization to manage one or more of their data sources is referred to herein as an “enterprise management system.”

Current BI tools usually only query the relational catalogs to populate the metadata layer with the explicit data model. Some may also use explicit name matching between columns to infer basic implicit referential integrity constraints. However, such techniques are not sufficient and the capture of the enterprise data model is a largely manual process and involves the BI implementers obtaining information from various sources within the organization. A lack of knowledge about the implicit data model within an organization often hinders this effort. Consequently, populating the metadata layer of BI tools becomes a time consuming, expensive and onerous process.

Thus, there exists a need for new and improved systems and methods for generating metadata relating to one or more data sources, particularly when such data sources are part of an organization's enterprise management system.

### SUMMARY OF THE INVENTION

It is therefore an object of the present invention to overcome disadvantages of the prior art by providing systems and methods that infer implicit elements of a data model within a data source, as well as infer elements of the data model that span across multiple data sources.

In accordance with a first aspect of the present invention, a method is provided for generating metadata relating to at least one data source having a one or more of tables and columns. The method includes a step of inferring constraints existing on at least one of the tables and columns in the data source based on data in the tables and columns. The method also includes a step of generating metadata that includes information on the inferred constraints.

In one embodiment, the method includes steps of:

A. identifying a set of data sources to be analyzed and connection information corresponding to each identified data source, and storing the identification of each data source and the corresponding connection information in a metadata repository;

B. for each data source identified in step A, determining one or more tables of interest from the each data source along with the column definitions for each table and storing the identified tables of interest along with the column definitions in the metadata repository;

C. for each table and column obtained in step B, determining a list of explicitly defined constraints for each table, and storing the list of explicitly defined constraints in the metadata repository;

D. generating column names obtained in step B to a user-friendly form by applying a function to each column name to generate aliases and storing the aliases in the metadata repository;

E. determining indices on each of the tables obtained in step B;

F. identifying view definitions including corresponding query statements for each of the data sources;

G. determining procedural code including corresponding query statements for each of the data sources;

H. obtaining a list of query statements that have been executed against each of the data sources;

I. normalizing each query statement identified in steps F through H to extract table and column information, storing the table and column information in the metadata repository;

J. identifying potential keys for each table identified in step C based on the table and column information of at least one of steps E through I and storing the potential keys in the metadata repository; and

K. identifying sets of columns that are not known to be potential keys that have similar names to potential keys identified in step J and storing the sets of columns as additional potential keys in the metadata repository.

According to another embodiment, the method includes steps of receiving table and column names; identifying one or more alternate names for each received table and column name; identifying potential relationships between the tables based on a similarity of alternate names; and outputting information defining the potential relationships.

In yet another embodiment, the method includes a step of identifying tables from the one or more disparate data sources to be analyzed. Next, aliases are identified for each of the columns in each of the tables. Next, a potential table relationship is identified when a column in a first table has a name or alias that is substantially the same as an alias of a column in a second table. Potential table relationships are stored in a metadata repository. Further, a step can be executed for identifying a number of rows in each table in the identified table relationship. A step of receiving a number of expected rows in each table associated with each identified table relationship can be performed, and a probability can be calculated for each table associated with the identified table relationship based on the number of rows and the number of expected rows.

In accordance with a second aspect of the present invention, a system for generating metadata for one or more data sources includes one or more computer program units configured to access one or more data sources and to generate metadata by inferring constraints based on data in tables and columns of at least one data source.

In one embodiment, the system for generating metadata relating to one or more disparate data sources includes means for identifying constraints on tables and columns in the one or more disparate data sources based on at least one of data in the tables and columns, and at least one query statement for accessing data in the tables and columns; and means for storing data relating to the inferred constraints in an accessible format. According to an embodiment of the present invention, a system for generating a metadata repository includes means for accessing one or more disparate data sources and means for analyzing the disparate data sources accessed to identify at least data objects, data constraints and data relationships for data in the disparate data sources. The system further includes means for generating a metadata repository comprising data about the data objects, data constraints and data relationships.

In accordance with a third aspect of the present invention, a computer-readable medium is provided which stores computer-executable instructions for generating metadata relating to at least one database having one or more of tables, each table having one or more columns, by performing operations including: inferring constraints existing on at least one of the tables and columns in the data source based on data in the tables and columns; and generating metadata comprising information on the inferred constraints.

Further applications and advantages of various aspects and embodiments of the present invention are discussed below with reference to the drawing figures.

### BRIEF DESCRIPTION OF THE DRAWINGS

FIG. 1 is a flow chart of a method of analyzing data sources to generate metadata according to an embodiment of the present invention.

FIGS. 2-20 are flowcharts illustrating exemplary sub-flows for each of the steps listed in FIG. 1.

FIGS. 21-22 illustrate respectively non-normalized data and normalized data in the form of database tables.

FIG. 23 is an exemplary entity relationship diagram according to an embodiment of the present invention.

FIG. 24 is block diagram of a system for analyzing data sources to generate metadata according to an embodiment of the present invention.

FIGS. 25A-C show exemplary user interfaces for a system for analyzing data sources to generate metadata according to an embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to the embodiments described and/or illustrated herein.

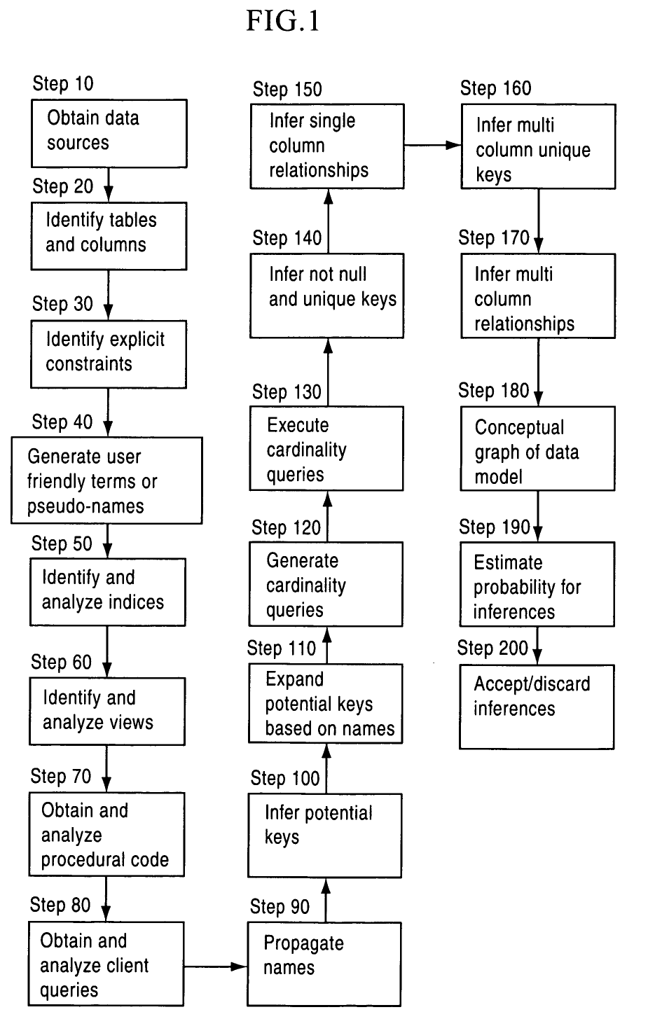

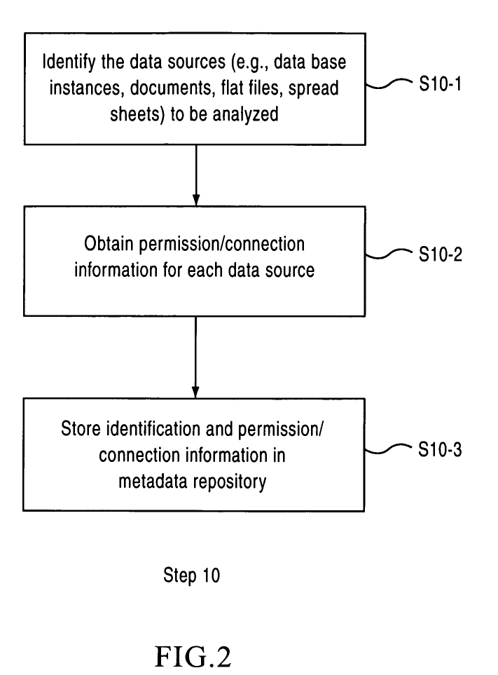

Referring to FIG. 1, a method for analyzing data sources to generate metadata for the data sources according to an embodiment of the present invention will be described. Exemplary sub-flows are illustrated for each of the steps of the method in FIGS. 2-20.

According to embodiments of the invention, some or all of the following steps can be automated programmatically and some or all of the results of each step can be stored in a metadata repository. One skilled in the art will recognize that the execution of some steps results in the generation of metadata while the execution of other steps results in data used in later steps. Therefore, data generated or obtained in each step is preferably stored in a metadata repository, such as an RDBMS, for use throughout the method. The metadata repository is not limited to databases, however, and can comprise flat files, XML documents or other data storage tools. Also, as used herein, the term “data source” is meant to include databases, such as relational and object oriented databases, data objects, tables, files, documents, flat files, data stores, spread sheets and any other electronic storage structures.

Referring to FIG. 1, each data source to be analyzed is identified in step 10. Exemplary sub-flows for this step are shown in FIG. 2.

As mentioned above, the first step (S10-1) includes identifying data sources to be analyzed. Connection information necessary to uniquely identify and connect to the data source is obtained or captured (S10-2) and used throughout the process for performing each step in the process. The identification of each data source along with the connection information may be obtained through user input, input files or any other means that may be used to provide input to a process.

The connection information may include a username and password, a URL or other network address, a Java Database Connectivity (JDBC) or other connection string, for example, or any other information necessary for accessing each data source for analysis. The information obtained is stored in the metadata repository (S10-3).

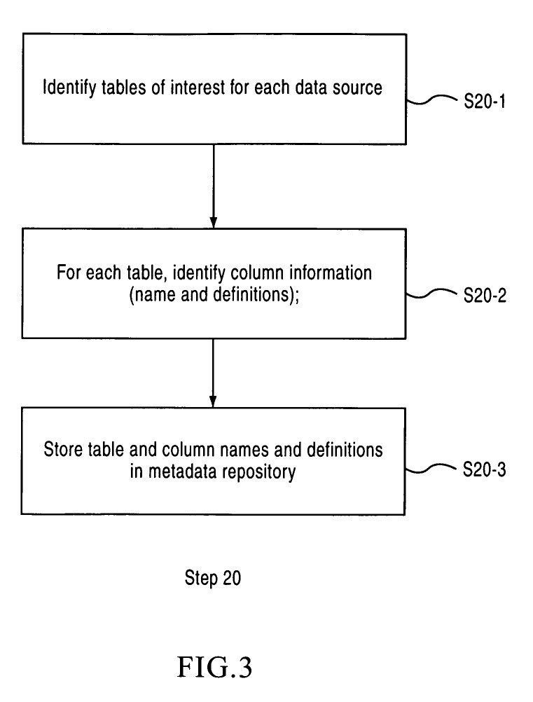

In step 20, table and column information is identified for each data source. Such information can be extracted from each data source, for example, from catalog tables and headers. Exemplary sub-flows for this step are shown in FIG. 3.

First, a set of tables of interest can be identified (S20-1). Preferably, it is presumed that all tables in each data source are to be analyzed, however, with extremely large databases (e.g., a database having about 10,000 or more tables), a user may be interested in only a subset of the database. Thus, the identification of each table of interest may be made manually (for example via a client interface or flat input file) or filters or the like may be utilized to limit which tables are analyzed by the present method. For example, all tables having a table name that includes the word “TEST” may be ignored. In another example, all tables having “ACCT” or “ACCOUNT” in the name are selected.

For each table to be analyzed, the column information is identified. For example, column name and definitions may be obtained (S20-2). This list may be obtained by directly querying the catalog tables in each database instance or by means of an interface that exposes such definitions.

Table name and column information may be obtained by querying the relational catalogs (i.e., catalog tables) or by alternate means such as an interface that exposes such definitions. The alternate means includes, but is not limited to, reading from a flat file or spreadsheets or XML or HTML files that contain this information. The information obtained in step 20 may be stored in the metadata repository (S20-3).

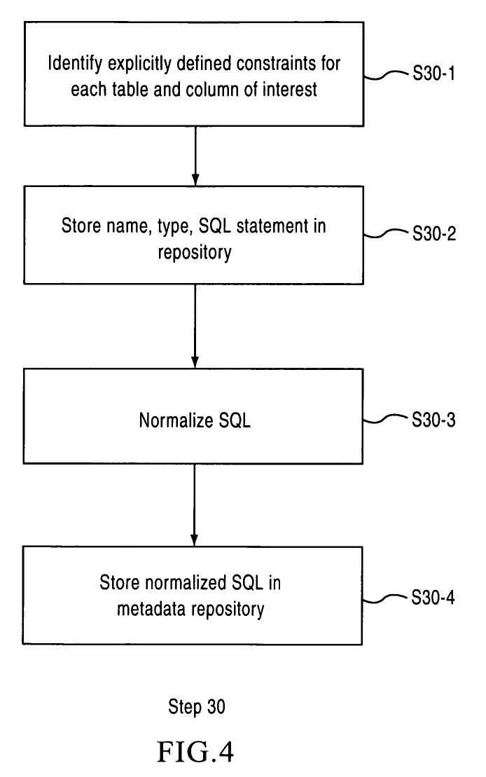

In step 30, for all tables and columns obtained in the previous step, a list of explicitly defined constraints is obtained. A constraint limits the set of values that constitute a valid relational state. As used herein, the term “explicitly defined constraints” includes constraints that are determined from the specific data model. Explicitly defined constraints are essentially validations of constraints on the data stored in the database. Thus, such constraints are facts that are always true about the data in a database (e.g., NOT NULL, check and foreign key constraints). Exemplary sub-flows for this step are shown in FIG. 4.

Constraints may be obtained by directly querying catalog tables (for example, ALL_CONSTRAINTS, ALL_KEY_CONSTRAINTS) or by means of an interface that exposes the definitions (S30-1).

Explicitly defined constraints may include, but are not limited to, NOT NULL, column-level and row-level check constraints, unique key constraints, primary key constraints, and referential integrity constraints.

The NOT NULL constraint on a column disallows the NULL value from being stored in that column. Check constraints may be at a column level or at a row level. A column level check constraint specifies a condition that the value in the column must satisfy to be valid and disallows data to be committed to the database unless the constraint is met. For example, a check constraint might require that the value of a column be positive. A row level constraint specifies a condition that a row of data must satisfy to be valid. As an example, the value of a Start Date might be required to precede chronologically the value of an End Date in the same row.

A unique key constraint specifies that the values of a given set of one or more columns in a table must be unique within that table. The set of columns on which a unique key constraint is defined is referred to as a unique key.

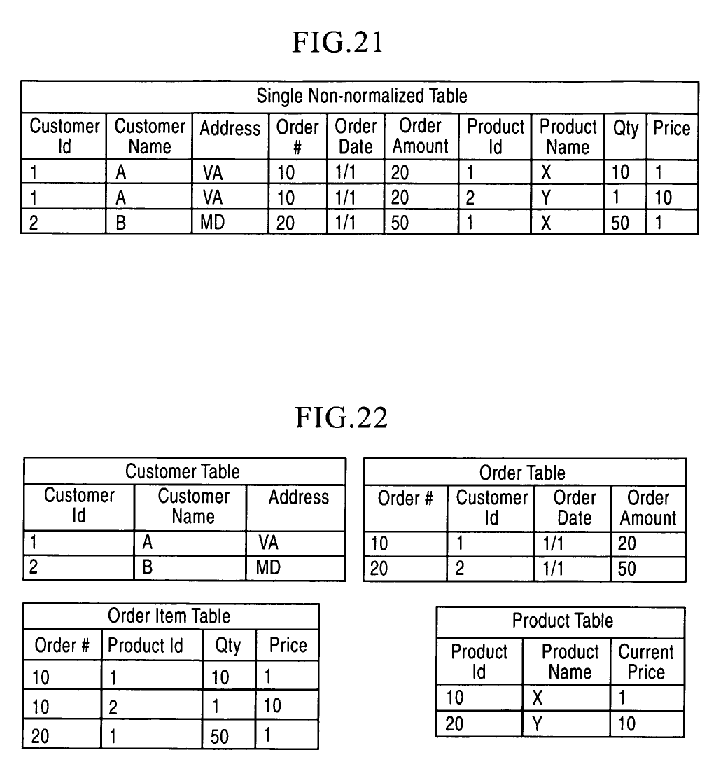

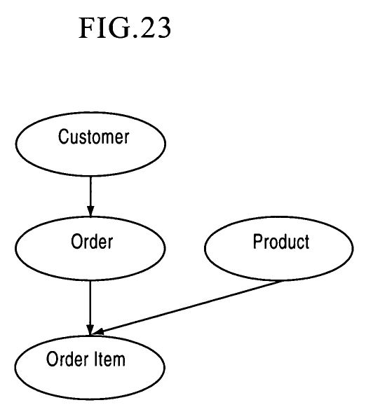

A primary key constraint is a combination of the unique key constraint and NOT NULL constraints on the given set of one or more columns. Only a single primary key constraint may be defined on any given table. The columns on which a primary key constraint is defined are referred to as the primary key. Referring to FIGS. 21-22, an example of a primary key is the Customer ID column in the Customer table.

A referential integrity constraint limits the values in a given set of one or more columns (called the foreign key) in a table (called the child table) to the set of values stored in a corresponding unique key or primary key in the same or another table (called the parent table). For example, where Order is the child table and Customer is the parent table, Customer ID in the Order table can be the foreign key corresponding to Customer ID in the Customer table, which is the primary key of the Customer table.

The constraints obtained in (S30-1) may be expressed as a SQL statement. This SQL statement can be stored along with the constraint name and type in the metadata repository (S30-2). As described in further detail below, rather than storing the SQL statement, or in addition to storing the SQL statement, useful information can be extracted from the SQL statement and stored. This process is called “normalizing” the SQL and is explained in further detail below with references to steps 60 and 70.

In step 40, alternate user-friendly terms also referred to herein as “aliases” or “pseudo-names”, are identified and/or generated for the column names of each of the columns identified in step 20. These aliases serve at least two purposes: first, aliases assist users with understanding the data; and second, these aliases are used in the method and system of the present invention to match column names and identify “similarly” named columns during the process of inferring table relationships.

In practice, columns are typically named to conform to the syntax requirements for names imposed by an RDBMS; and, accordingly, acronyms, abbreviations or other names are often used that are not easily understandable by the user. Thus, there exists a need to provide alternate user-friendly versions of column names and table names in the form of pseudo-names or aliases that can be understood by those not having intricate knowledge of a data model.

There are issues associated with generating alternate names from the column names. For example, column names may include underscores, rather than spaces, to separate words. Alternatively, uppercase characters may be used as word separators. When uppercase letters are used to begin a new word, the RDBMS typically does not retain the exact case of each letter in the names in its catalog (i.e., all letters are stored in uppercase). Hence it might not be possible to determine word beginnings in an RDBMS. As mentioned above, names may also contain acronyms to shorten the names.

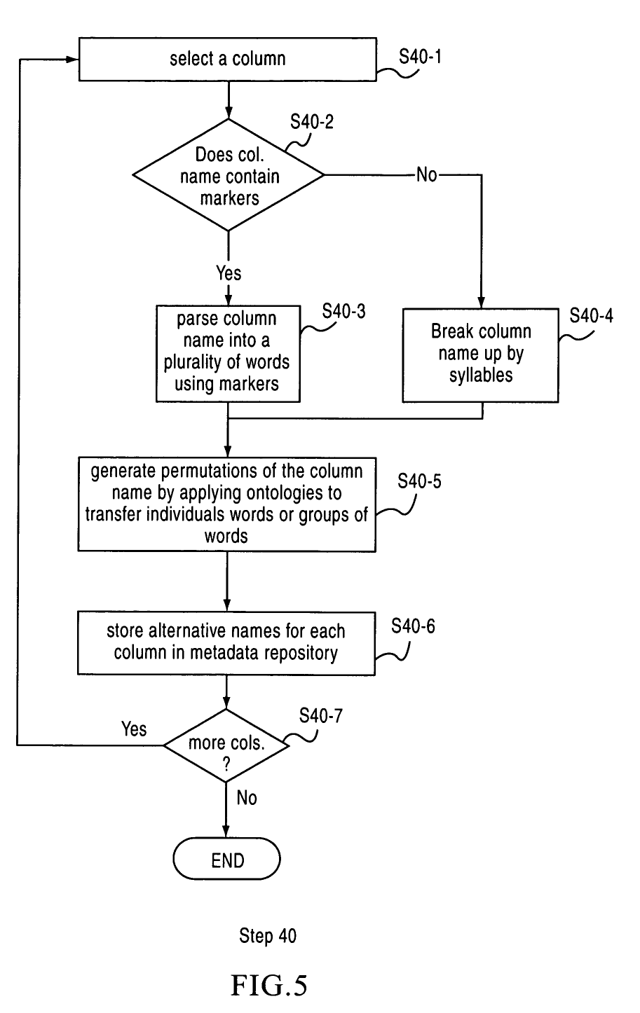

Exemplary sub-flows for step 40 are shown in FIG. 5.

According to an embodiment of the present invention, a function F is used to convert a column name into one or more alternate user-friendly names, i.e. pseudo-names or aliases, according to the following steps:
a. The column name is broken up into words by breaking up the column name at word boundaries such as the underscore character or capitalized letters (S40-1, S40-3).
b. Various permutations of the consecutive words (the entire column name if one word) are identified from pre-defined and user-definable ontologies (S40-5). A name ontology, as viewed in this context, is a set of rewrite rules for names. Such lookups need not be exact and may be based on techniques such as regular expression matching, relevance scoring and/or may be based on context such as the rest of the column name, the table or relation name or any other such context. If a particular set of consecutive words is found in the ontologies, then those words are replaced by a user-friendly pseudo-name or alias as suggested in the ontology.
c. When a column name cannot be broken into words and the entire column name itself cannot be looked up in any ontology, the column name may be broken up into syllables (S404) and then a combination of successive syllables may be looked up in the ontologies as described above.

Various ontologies for creating pseudo-names are well known in the art and readily available. The following is one example of a rule that transforms all names ending in “id” by replace it with “identity.”
(.*)\sid->($1)\sidentity
   The above transformation uses regular expression to define the transformation. The (.*) matches any set of characters. The \s represents a word separator. The ( ) that encloses .* cause all the characters that match .* to be put in the variable $1. Thus the right hand side of the equation transforms and retains all the words other than the trailing “id” and replaces the trailing “id” with “identity.”

The name ontologies can be used to represent transformation rules specific to a domain. The system allows a user to associate a set of ontologies with each data source. Thus column names in that data source are transformed using the domain-specific name ontologies that the user selects.

The pseudo-names for each column name may be stored in the metadata repository (S40-6). A record may be explicitly created with the column name itself as the pseudo-name, or the record can simply be omitted but implied.

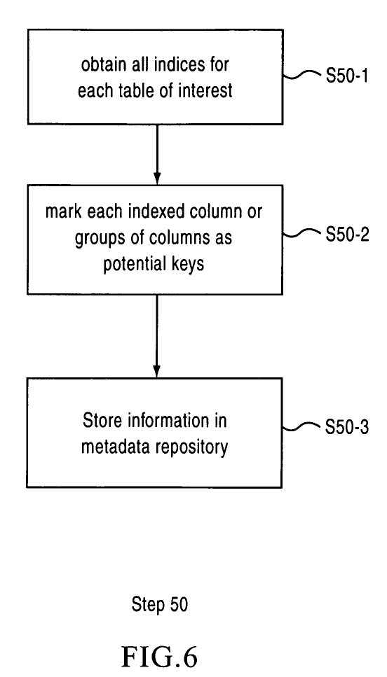

In step 50, all indices on all the tables obtained in step 20 are obtained. Exemplary sub-flows for this step are shown in FIG. 6.

Indices may be obtained by directly querying the catalog tables in the appropriate database instances or by means of an interface that exposes the index definitions (S50-1). All the subsets of the set of columns in each index definition are marked as “potential” keys for the table on which the index is defined (S50-2). Thus, for example, if a composite index exists on columns a, b and c on table T, columns a, b and c are individually marked as potential keys. The sets {a, b}, {a, c}, {b, c} and {a, b, c} are also marked as potential keys. These potential keys are used to infer implied single-column or multi-column relationships between tables as described in subsequent steps. The information may be stored in the metadata repository (S503).

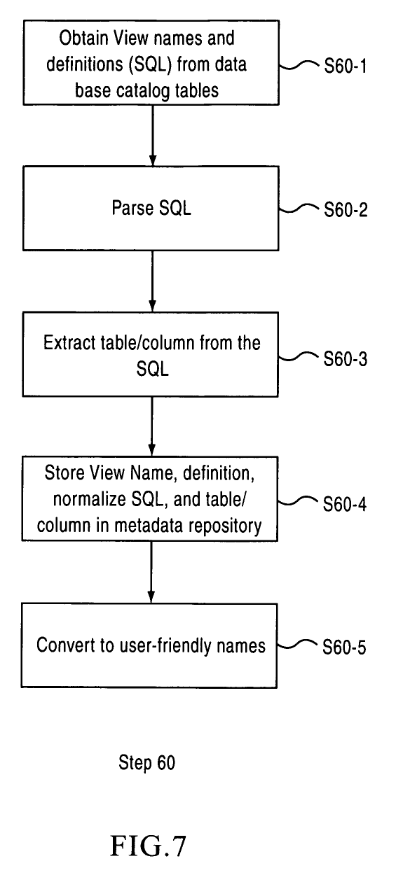

In step 60, all view definitions for all the database instances are obtained. Exemplary sub-flows for this step are shown in FIG. 7.

As used herein, the term “views” means named queries. Views are defined by SQL queries in most RDBMS. View definitions can be extracted from the catalog tables in an RDBMS (S60-1). Wherever a table name may be used in a query, a view may be used instead. Thus, a query may be reused without having to repeat it in its entirety. The view query statements are analyzed to aid in the inference (S60-2). For the purpose of such analysis, the query is first parsed and normalized. The normalization process is carried out as follows:

If the query references any views, the views are expanded. This process is repeated until no views are referenced in the query.

SQL allows joins to be specified in two ways, either by specifying the join condition as part of the WHERE clause or by specifying the join predicate as part of the FROM clause. The following are examples of two queries that are semantically the same
SELECT *
FROM a, b
WHERE a.f1=b.f2 AND a.f3=?
   and
SELECT *
FROM a INNER JOIN b ON a.f1=b.f2
WHERE a.f3=?

The second form is preferable since it clearly separates out the join predicates. Not all RDBMS support the second form. To aid further analysis, any query in the first form is converted to a query in the second form.

A query may contain sub-queries. The sub-queries may in turn contain other sub queries and so on. The sub queries may be correlated (i.e., refer to a value from the containing queries). For example, the following query contains the correlated sub-query (SELECT * FROM b WHERE b.f2=a.f1)
SELECT *
FROM a
WHERE EXISTS (SELECT * FROM b WHERE b.f2=a.f1)

The following query contains no correlated sub-queries but is semantically the same. It contains the non-correlated sub-query (SELECT b.f2 FROM b):
SELECT *
FROM a
WHERE a.f1 IN (SELECT b.f2 FROM b)

Sub-queries provide useful information about potential join paths between tables. To aid further analysis, sub-queries are transformed into the second form of joins described in the previous step. Thus, both the above queries would be re-expressed as the query:
SELECT *
FROM a
INNER JOIN (SELECT DISTINCT b.f2 FROM b) b
ON a.f1=b.f2

SELECT DISTINCT <column list> queries are converted into SELECT <column list> GROUP BY <column list> queries.

Queries involving the UNION set operation are split into individual queries. This applies to even inner queries. Thus, if a query contains three inner queries that are each unions between two tables, a total of eight queries are obtained by treating each UNION query as an individual query.

Queries involving the EXCEPT set operation are converted into LEFT OUTER JOIN that only returns rows when the right hand table does not have a corresponding row. Thus, the query
SELECT a.f1
FROM a
EXCEPT SELECT b.f2
FROM b
   is transformed into the form
SELECT a.f1
FROM a LEFT OUTER JOIN b ON a.f1=b.f2
WHERE b.f2 IS NULL.

After the above transformations, the normalized query would contain other queries only in the FROM clause. Such queries can in turn contain other queries in their FROM clause. The list of tables and queries in the FROM clause are referred to as correlations. Correlations in a normalized query may refer to tables or other queries (S60-3).

Any queries that are part of a FROM clause in a normalized query are added to the set of queries that are used for further analysis. The information may be stored in the metadata repository (S604).

The normalized query itself is also added to the set of queries used for further analysis.

The view definition itself is included within the enterprise data model much like the table definitions along with the view column definitions. This includes computed columns. The column names are again converted into user-friendly names as described in step 40 and may be stored in the metadata repository (S60-5).

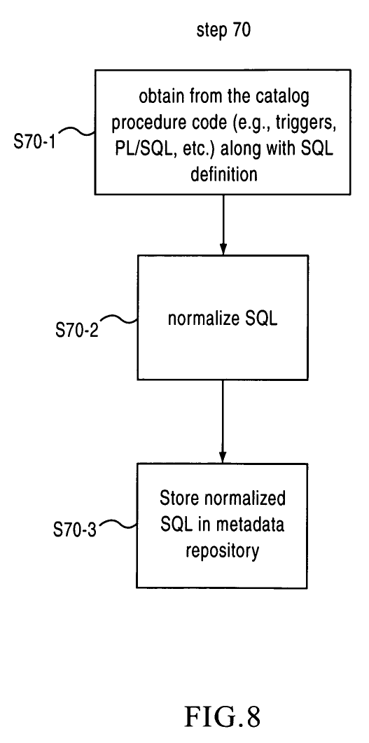

In step 70, available procedural code is obtained for each database source. Exemplary sub-flows for this step are shown in FIG. 8.

Exemplary procedural code includes code in the form of triggers, procedures, functions and packages, as well as code embedded or contained in any triggers, procedures functions and packages. Procedural code may be extracted from the data source (S70-1).

SELECT queries are normalized (S70-2) as follows:

The query is parsed. If the SELECT query contains a clause to fetch data into host variables, that clause is culled out from the SELECT query. The list of column expressions in the SELECT clause is matched against the list of host variables. If a column expression is not in the form of a pseudo-name or alias, then the name of the host variable that it is fetched into is used as an alias for that column expression.

Thus the following query:
SELECT f1, f2
INTO ?x, ?y
FROM a
   is transformed into the query
SELECT f1 AS x, f2 AS y
FROM a

The SELECT query is then normalized as described in step 60.

UPDATE queries are analyzed by converting them into SELECT queries. For example, UPDATE queries of the form
UPDATE x
SET f2=(SELECT f3 FROM z WHERE z.f4=y.f2)
FROM y
WHERE x.f1=y.f1
   are converted into the form
SELECT z.f3
INTO ?
FROM x, y, z
WHERE x.f1=y.f1 AND y.f2=z.f4

DELETE queries are converted to SELECT queries in a manner analogous to the manner in which UPDATE queries are converted to SELECT queries.

Converted queries are normalized in a like fashion as SELECT queries. The normalized SQL may be stored in the metadata repository (S70-3).

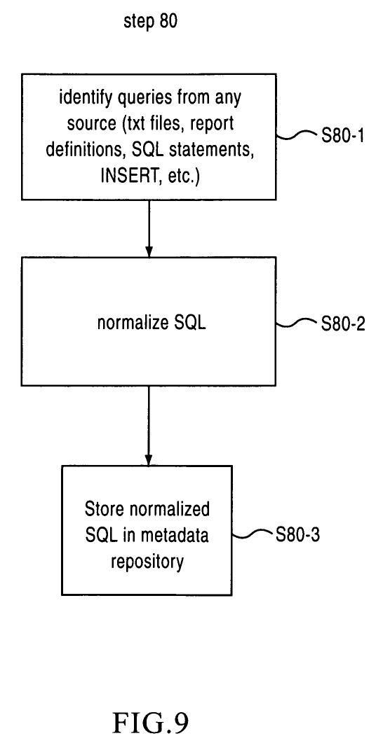

In step 80, a list of all available queries that are run against each data source identified in step 10 is obtained. Exemplary sub-flows for this step are shown in FIG. 9.

Query code may be in the form of SQL code or the like and may be obtained from query logs (i.e., records of executed queries maintained by the DBMS), from client-side SQL logs (i.e., logs generated by ODBC/JDBC connections), from text files that contain a list of all queries that are typically used by the MIS staff, from user input, or from a combination of any of these or similar sources (S80-1). All queries obtained through such means are analyzed and normalized in the same manner as described above with respect to step 70 (S80-2). The normalized SQL may be stored in the metadata repository (S80-3).

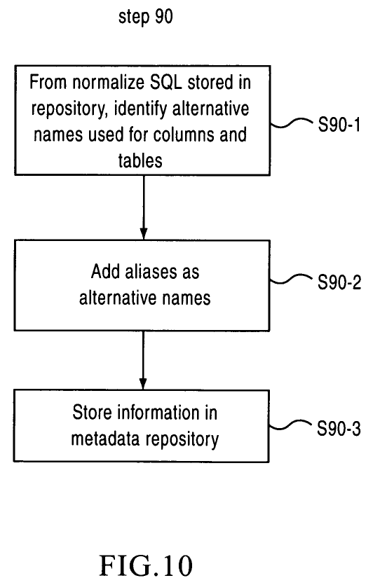

In step 90, name propagation is performed for all queries or sub-queries obtained during the normalization process. The purpose of the name propagation is to generate alternate names (i.e., pseudo-names or aliases) for columns in tables or views. In all cases, the names are generated as already described with respect to step 40. Exemplary sub-flows for this step are shown in FIG. 10.

The name propagation for a single query proceeds as follows:
a. The SELECT clause is inspected.
b. Only expressions that are explicitly aliased are considered (S90-1).
c. An expression in a SELECT clause will either be an expression or a simple column reference. For simple column references, the correlation that is the source of the column is inspected. If it is a table, the alias is used to generate an alternate name for the referenced column in that particular table (S90-2).

For simple column references, if the correlation is a query, the column alias is propagated inwards. An example wherein an alias is propagated inwards is as follows: Given a query of the form:
SELECT a.f1 AS name, a.f2 * a.f3 AS value, b.f4, b.f5-f6 AS diff FROM a INNER JOIN (SELECT f, f4, f5, f6 FROM t) b
   ON a.f=b.f
      the alias “name” is used to generate an alternate name for f1. f2 * f3 is defined as a computed column on table a and the inner query will be transformed into the form
SELECT f. f4, f5, f6, t.f5-t.f6 AS diff FROM t
a. If the expression is not a single column but based on columns from one and only one correlation, then again the correlation is inspected. If it is a table, the expression is defined as a computed column on that table with the name derived from the alias.
b. If in the above case, the correlation is instead a query, then the expression is moved inwards.
c. Sub-queries that had aliases or sub-expressions moved inwards are then analyzed by a repetition of the above steps.

This transformed inner query will in turn result in the computed column f5-f6 being defined as a compute column on table t. The information may be stored in the repository (S90-3).

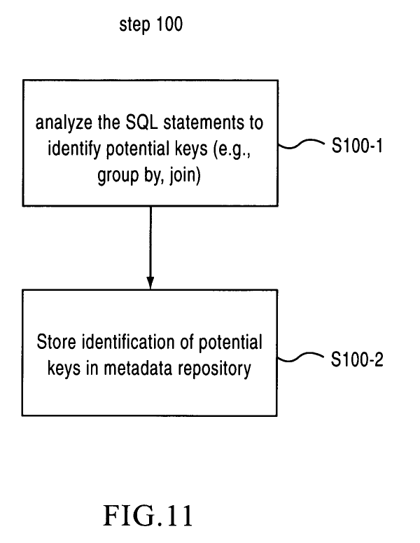

In step 100, the results from the normalization process described in step 60 are analyzed to identify potential keys in the tables. In the method of the present invention, the normalization process is used to identify potential keys. Exemplary sub-flows for this step are shown in FIG. 11.

In S100-1, all correlations in the FROM clause of the normalized query are inspected. If a correlation maps to a table, the set of all columns of that table that are specified as part of the predicates in the FROM or WHERE clauses or as part of the GROUP BY clause are obtained. All subsets of this set are marked as potential keys for that table. For all the correlations that are queries, the columns from the correlation referenced in the outer query can be transposed inwards into the inner query in the form of “dummy” predicates. Then the same process of marking potential keys is applied to the inner query as described in this step.

To illustrate the above, for example, if the normalized query to be analyzed is:
SELECT a.f9, b.f3, SUM(b.f10)
FROM a INNER JOIN
   (SELECT b.f2, c.f3, c.f10 FROM b INNER JOIN c ON b.f4=b.f5)
d ON a.f1=d.f2
   WHERE a.f8=?
GROUP BY a.f9, b.f3
   the correlation a refers to a table. f1, f8 and f9 are the three columns of the table that are used in predicates in the FROM, WHERE and GROUP BY clauses. Thus, all subsets of {f1, f8, f9} are marked as potential keys for table a. The correlation d is a query. The columns from this correlation that are referenced in the FROM, WHERE and GROUP BY clauses of the outer query are transposed inwards to yield the query:
SELECT b.f2, c.f3, c.f10
FROM b INNER JOIN c ON b.f4=c.f5
WHERE b.f2=? AND c.f3=?

This query in turn contains two correlations, b and c, both of which are tables. Since columns f2 and f4 from table b are used in predicates in the query, all subsets of {f2, f4} are marked as potential keys in table b. Similarly all subsets of {f3, f5} are marked as potential keys in table c. The identified potential keys may be stored in the metadata repository (S100-2).

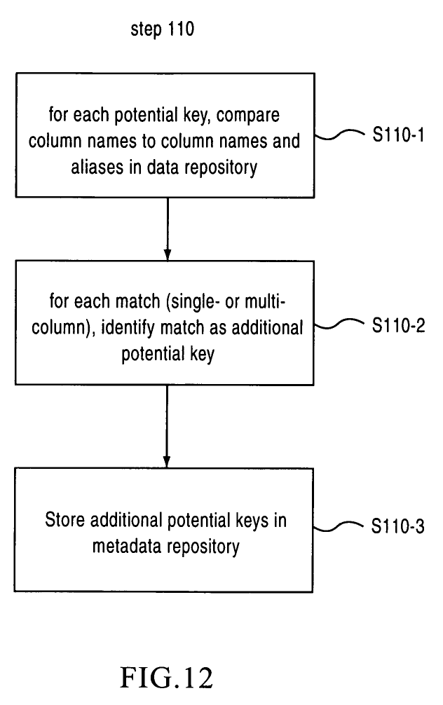

In step 110, the set of potential keys is expanded by adding sets of columns that are not known to be potential keys but have similar names to known potential keys. Exemplary sub-flows for this step are shown in FIG. 12.

For each potential key, the column name is compared to column names and aliases in the repository (S110-1). Each match is identified as a new potential key (S110-2) and may be stored in the repository (S110-3).

For example, if S1 is a known potential key containing the columns c1 and c2, and S2 is any set containing columns c3 and c4, wherein S1 and S2 do not have any elements in common, if it is determined that the name of c1 is similar to that of c3, and c2 has a name similar to c4, then S2 is also added as a potential key.

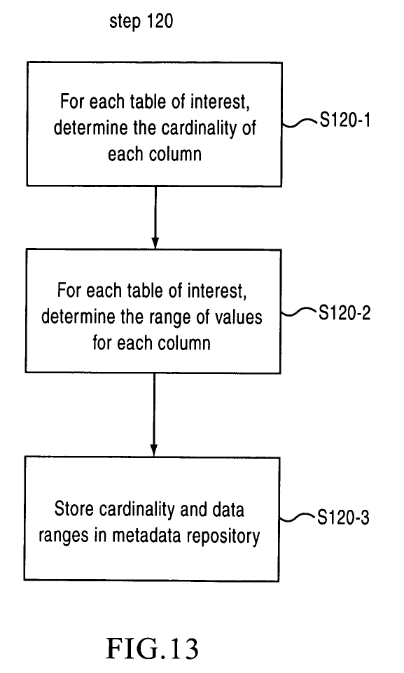

In step 120, the cardinality of each table identified in step 20 is obtained. “Cardinality” as used herein with respect to a table means the number of rows in a table. Similarly, the phrase “cardinality of a column” means the number of non-null values in a given column. The implied domain set of a column is the set of all distinct non-null values for the column. The cardinality of the implied domain set of a column is the number of distinct non-null values for the column. Exemplary sub-flows for this step are shown in FIG. 13.

A query statement can be generated to calculate the cardinality (S1201) and range of values (S120-2) of columns of interest in these tables. The results of these queries form the basis for inferring the implicit NOT NULL, single column unique key or primary key constraints. For example, if table t has columns a, b and c, the following exemplary SQL statement may be generated:
SELECT COUNT(*), COUNT(a), COUNT(DISTINCT a), COUNT(b), COUNT(DISTINCT b), COUNT(c), COUNT(DISTINCT c) FROM t

If the result of the COUNT(<column>) expression is same as the result of the COUNT(*) expression, the implication may be made that in the current relational state, that column does not store any NULL values. If the result for a COUNT(<column>) is the same as the COUNT(DISTINCT <column>) expression for the same column, the implication can be made that in the current relational state, all the non NULL values for that column are distinct or unique.

To break down the query further, the COUNT(*) provides the cardinality of the table; COUNT(<column>) provides the cardinality of the particular column in the table t; and COUNT(DISTINCT <column>) provides the cardinality of the domain set implied by the current relational state for that column in the table t. If the cardinality of the column is the same as the cardinality of the table, then it is determined that the column does not contain any NULL values. Similarly, if the cardinality of the column is the same as the cardinality of the implied domain set for that column, then it is determined that the column contains only unique values.

The COUNT(<column>) and COUNT(DISTINCT <column>) are indicative of the column specific expression that could be part of the generated query and may not be necessary if one were to take into account existing knowledge about the domain. For example, if the column is explicitly defined as NOT NULL, the COUNT(<column>) is not necessary as it will always be same as the COUNT(*). Similarly, if the column is explicitly defined as a unique key in the DBMS, then the COUNT(DISTINCT <column>) is not necessary. If the column is explicitly defined as NOT NULL, the COUNT(DISTINCT <column>) is the same as COUNT(*) for COUNT(<column>). If the column does allow NULLs, then COUNT(DISTINCT <column>) is the same as COUNT(<column>). Additionally, if the DBMS does not ignore NULLs from the uniqueness check, then COUNT(<column>)=COUNT(*) or COUNT(<column>)=COUNT(*)−1. Similarly, certain other expressions such as MIN(<column>), MAX(<column>) may also be useful in addition to the COUNT(<column>), COUNT(DISTINCT <column>) expression. The MIN and MAX values may be used to determine the range (difference between the minimum and the maximum) for the implied domain set of a column.

The generation of the SQL can proceed as follows: The COUNT(*) is added to the select clause. A function f is then applied to each column in that table. This function returns all the expressions on the given column that should be part of the select clause. These returned expressions are duly added to the SQL. This function may omit the COUNT(<column>) if the column has a NOT NULL constraint. It may also omit the COUNT(DISTINCT <column>) if the column is defined as a unique key. A default implementation may add the expressions MIN(<column>), MAX(<column>), MIN(LENGTH(<column>)) and MAX(LENGTH(<column>)) for VARCHAR columns. It may add the MIN(<column>) and MAX(<column>) expressions for integer or date time columns. It may also omit all expressions in cases where it is believed that the column may not be part of a unique or primary key. Examples of such columns may be columns that store decimal amounts or floating point data or columns that store creation/modification timestamps, version stamps or users. The determination of whether columns store creation/modification timestamps, version stamps or users can be made based on predefined or configurable ontologies. If there is an indication that the column name obtained from the known ontologies represents such timestamps, version stamps or users, then the column is treated as such.

The cardinality and ranges may be stored in the metadata repository (S120-3).

In step 130, each query generated in step 120 is executed and the results may be stored. Each table is queried only once without any joins. The queries generated in step 120 could be formulated as multiple queries per table instead of one query per table. For example, one query could be generated for expressions of each column. However this would require multiple scans of each table and would thus increase the time complexity.

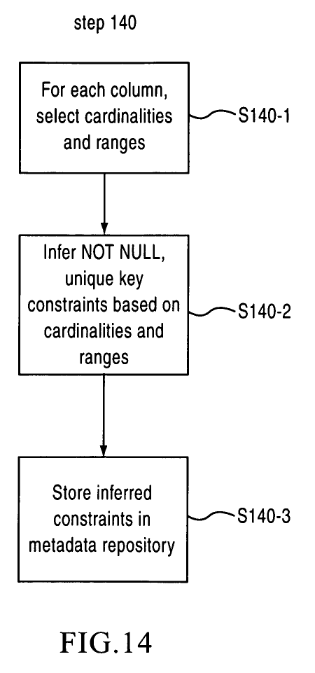

In step 140, for each column, constraints are inferred. Exemplary sub-flows for this step are shown in FIG. 14.

The cardinality and ranges are selected from the repository (S140-1). The cardinalities obtained by executing the queries in step 130 are used to infer NOT NULL and unique key constraints (S140-2). The logic for this inference is described in step 120. The inferred constraints may be stored in the metadata repository (S140-3).

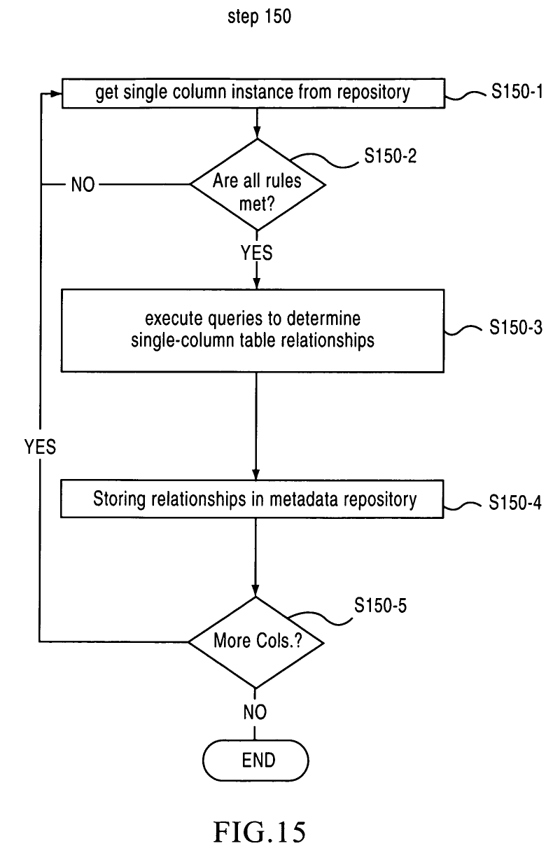

In step 150, implicit single column table relationships are inferred. Exemplary sub-flows for this step are shown in FIG. 15.

For each column in the repository (S150-1), queries are executed to determine table relationships (S150-3), and the table relationships may be stored in the metadata repository (S150-4).

For example, given table p, table c, column u in table p and column f in table p, table c is a child of table p with foreign key f referencing column u if and only if the following template SQL returns 0:
SELECT COUNT(*)
FROM c LEFT OUTER JOIN p ON c.f=p.u
WHERE c.f IS NOT NULL AND p.u IS NULL

The above represents a rigorous test for determining relationships. Often, however, data may not satisfy such a rigorous test as described above, but may still be related. For example, applications performing inserts/updates on a child table may be storing values such as 0 or an empty string instead of NULLs in the columns. Such values are often referred to as sentinel values in the art. Further, data may be initially inserted in the referencing columns such that it matches the data in the referenced columns. However, the data in the referenced column may be subsequently deleted or updated without updating of the referencing columns. This could be a systematic behavior that applications maintaining the data sources exhibit or it could be outlier cases where certain steps may have been erroneously skipped.

For the purpose of identifying join paths, even relationships that do not satisfy the rigorous criteria stated above are important. Thus, instead of obtaining an “either-or” result using the above criteria, a probability is computed for the relationship based on the distribution of values that match or do not match. Specifically, the following query is executed to test the relationship:
SELECT
   COUNT(*) AS total_child_rows,
   COUNT(p.u) AS matched_child_rows,
   COUNT(DISTINCT c.f AS distinct_child_values,
   COUNT(DISTINCT p.u) AS distinct parent_values
FROM c LEFT OUTER JOIN p ON c.f=p.u
WHERE c.f IS NOT NULL.

If the total_child_rows returned by this query matches the total_parent_rows, then the rigorous test would also be satisfied and the highest probability (1) is assigned to this inference. Otherwise, this inference is assigned a probability computed as MAX(matched_child_rows/total_child_rows, distinct_parent_values/distinct_child_values). If this probability is below a certain threshold, the inference is automatically rejected. MAX is merely indicative of a function that might be used to compute the probability based on the two ratios: the first ratio (r1) being number of child rows that matched and the second ratio (r2) being the number of elements in the domain set of the child that matched the domain set of the parent. The general idea of any function defined on these two ratios would be to reward a high value for any ratio. An alternative to the MAX is SQRT(SQR(r1)+SQR(r2))/SQRT(2).

If the distinct_parent_values is less than distinct_child_values by only 1 or some other very small number, presuming distinct_child_values is not a very small number, a test may be performed to see whether the unmatched values are all sentinel values. If so, then the probability assigned to the inference may be “boosted” by applying a certain multiple greater than 1. The rationale for the boost being that the sentinel values are almost like NULLs and thus should not considered for testing matches. An allowance for a single possible sentinel value could be made by adding the column:
MIN(CASE WHEN p.u IS NULL THEN c.f ELSE NULL END)
   to the above query. Thus, the tables do not need to be rescanned. To test whether only sentinel values have not matched, it is necessary to test the sentinel value against the value returned by the query for this column.

Note that the values of total_child_rows and distinct_child_values can be obtained from the metadata repository itself as a result of the processing in step 130. The above query is an example intended to demonstrate the values required for performing the inference and the assignment of a probability to it. The actual query may be optimized in various ways to reduce computing costs.

If the processing described above indicates that p is a parent of c, the relationship type is determined to be one-to-one if both u and f are unique keys. It is one-to-many if u is a unique key but f is not a unique key. The relationship type is determined to be many-to-many if neither f nor u is a unique key. Note that p being parent of c with foreign key f in c referencing column u in p does not preclude c from being a parent of p with foreign key u in p referencing column f in c. Neither are p and c precluded from being the same table. However f and u may not be the same column in the same table as such a relationship would always exist and is hence trivial.

Executing the above query for each possible pair of columns can yield all single column relationships implied by the current relational state, however executing such a query for each and every pair of columns can often be infeasible. For example, executing the query for a model with only 1000 columns would involve executing nearly a million queries with two tables scanned for each query. In order to make the inference feasible, the following heuristics and restrictions may be applied to determine whether to test column f in table c as a potential foreign key that references column u in table p (S150-2). Preferably, every test must be satisfied for the test to be performed:
a. If f has been explicitly defined as a foreign key that references u, the test is not performed.
b. Only one-to-many or one-to-one relationships are tested for. Thus u must be a unique key for the test to be performed. This restriction is justified because many-to-many relationships are uncommon and usually always modeled by adding a common parent table during normalization. If c1 (column 1) and c2 (column 2) have a many-to-many relationship through column f1 in c1 and column f2 in c2, during normalization, a table p is added with primary key u. All distinct values that are stored in columns f1 and f2 are also stored in u. Thus the many-to-many relationship is converted into a one-to-many relationship between p to c1 and p to c2. This restriction drastically reduces the search space for inferring implicit single level table relationships. For example, in f a database with 1000 columns, having 50 unique/primary keys, instead of having nearly one million queries to execute, the complete inference requires only 50,000 queries.
c. The domains of column f and column u are compatible. Thus, if column f is an INTEGER column and column u is a VARCHAR column, the test is not made.
d. The cardinalities of the implied domain sets of column f and column u captured in step 130 are compared. If the cardinality of the domain implied domain set of f is greater than the cardinality of the implied domain set of u, one can infer that a rigorous foreign key relationship does not exist. In order to test for less than rigorous relationships, the cardinality of the implied domain set of u may be divided by the cardinality of the implied domain set of f giving a certain ratio. If this ratio is less than a configurable threshold, the test is not performed.
e. For VARCHAR columns, if the range of the length of f does not lie within the range of the length of u, the test is not made. This test is skipped if non-rigorous relationships need to be included in the inference.
f. The range of f itself is compared with the range of u. If the range of f does not lie within the range of u, the test is not made. This test is skipped if non-rigorous relationships need to be included in the inference.
g. Optionally, the names of columns f and u may be compared and the test may not be performed if the names are not similar.
h. Optionally f may be tested if and only if it is known to be a potential key as identified in one of the previous steps. If not, the test need not be made.
i. If the criteria listed above do not imply that the test should be skipped, the test is made and a probability is computed as described above. If the computed probability is below a threshold, the inference is ignored. Otherwise the inference is stored in the metadata repository along with the associated probability.
j. It must be noted that p and c may be stored on separate database instances. In such a case, executing the test query directly may not be an option. In such instances, data from one instance may be copied to a temporary table on another instance or if such an operation were not possible, data from both instances may be copied to a common instance that may be an in-memory database and the query executed accordingly. Any temporary tables may not be dropped until the analysis is completed in case the same data needed to be queried again. Also entire tables may be copied instead of a single column or a limited set of columns. An optimizer determines the exact approach.

The relationship information may be stored in the metadata repository (S150-4).

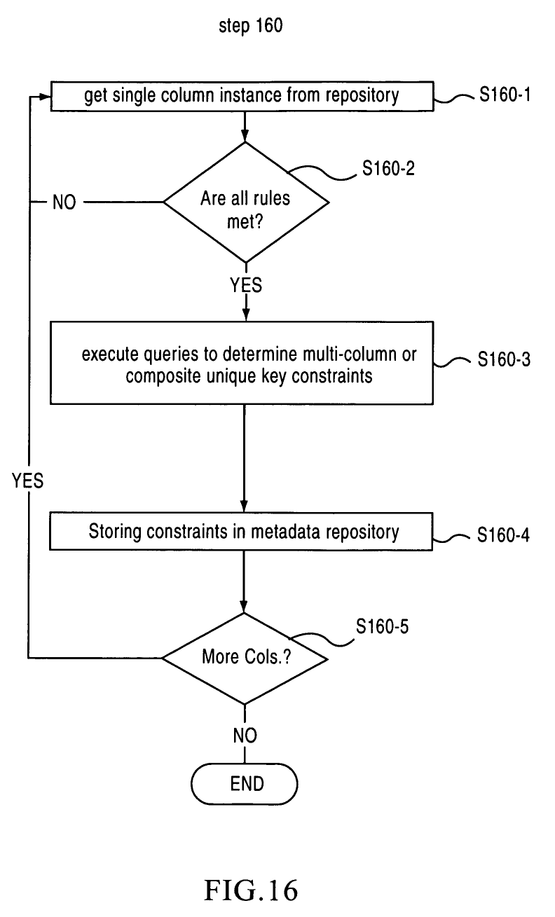

In step 160, multi-column or composite unique keys are inferred. Exemplary sub-flows for this step are shown in FIG. 16.

For each set of multiple columns in a table in the repository (S160-1), queries are executed to infer key constraints (S160-3), and the inferred constraints may be stored in a metadata repository (S160-4).

For example, given a table T, a set of columns C such that each element of C is a column in T, the columns in set C represent a unique key on table T if and only if the following template query returns no rows:
SELECT <each column in C as part of the select clause>
   FROM T
   WHERE <at least one column in C is non NULL>
   GROUP BY <each column in C as part of the group by clause>
   HAVING COUNT(*)>1;

Executing the query for each possible set C of the columns in table T should yield all of the implied multi column unique keys for table T. However, even for a small table of for example, twenty columns, there are 2²⁰—in excess of over 4 billion—such possible combinations. Thus, the simple approach of executing this query for every possible combination of columns is clearly infeasible. Instead, the following heuristics and restrictions are applied (S160-2) to keep the number of such possible sets C to test to a manageable level:
a. If a set S is explicitly defined or implicitly known to be a key for table t, all C that are a superset of S will also represent a unique key. Thus, while generating potential sets C, supersets of known unique keys, including single-column unique keys, need not be generated.
b. Columns of certain data types such as decimal amounts, floating-point values or text or image columns are usually not used as components of unique keys or are sometimes not even allowed as components of unique keys. Hence such columns need not be included in generation of potential set C.
c. For columns c1, c2, . . . , cn−1, wherein cn are all the elements of set C, C may be a unique key only if the product of cardinality of the implied domains of columns c1, c2, . . . , cn−1, cn with 1 added to the cardinality for each column that has NULLs is greater than or equal to the cardinality of t. Thus if t has 24 rows, column a has only 2 distinct values and does not allow NULL and column b has 3 distinct values and allows NULLs, the product of the “adjusted” cardinalities of a and b is 2*(3+1)<24. Hence {a, b} cannot be a unique key of t.
d. If the number of elements in C exceeds a certain configured threshold (2 by default), C is treated as a potential key if and only if C has been marked as a potential key in any of the previous steps.

For each unique key test made for the set of columns C, if the test succeeds, the set of columns C is marked as an implied unique key for the pertinent table.

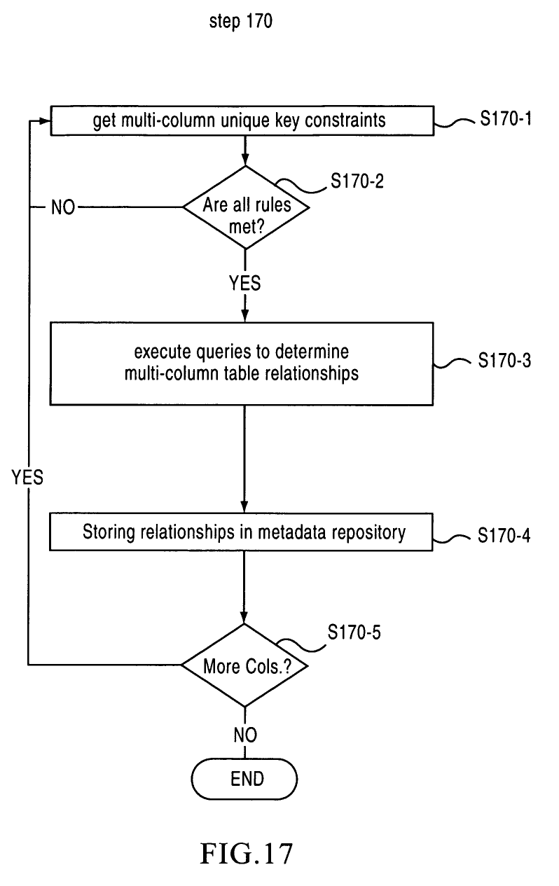

In step 170, multi-column table relationships are inferred. This analysis is similar to that of step 150 and uses the multi-column unique keys inferred in step 160. Exemplary sub-flows for this step are shown in FIG. 17.

For each multi-column unique key in the repository (S170-1), queries are executed to determine multi-column table relationships (S170-3), and the table relationships are stored in the metadata repository (S1704).

For example, given table p, table c, an ordered list of columns U={u1, u2, . . . , un} in table p and an ordered list of columns F={f1, f2, . . . , fn} in table c, where the number of columns in U is same as the number of columns in F, table c is determined to be a child of table p with the columns in U referencing the columns in F if and only if the following template SQL returns 0:
SELECT COUNT(*)
FROM c LEFT OUTER JOIN p
ON c.f1=p.u1 AND c.f2=p.u2 AND . . . AND c.fn =p.un
WHERE NOT (c.f1 IS NULL AND c.f2 IS NULL AND . . . AND c.fn IS NULL) AND (p.u1 IS NULL AND . . . AND p.n IS NULL)
   Again, the above tests for only rigorous multi-column table relationships. To infer less than rigorous multi column relationships, the following query may be used:

```
SELECT
    SUM(no_of_rows) AS total_child_rows,
    SUM(no_of_matches) AS total_matched_rows,
    COUNT(*) AS distinct_child_values,
    COUNT(CASE WHEN no_of_matches > 0 THEN 1 ELSE NULL)
        AS distinct_parent_values
FROM (SELECT
        c.f1, c.f2, ..., c.fn,
        COUNT(*) AS no_of_rows,
        COUNT(CASE
            WHEN p.u1 IS NULL AND ... AND p.n IS NULL
                THEN NULL
            ELSE 1
        ) AS no_of_matches
    FROM c LEFT OUTER JOIN p
        ON c.f1 = p.u1 AND c.f2 = p.u2 AND ... AND c.fn = p.un
    GROUP BY c.f1, c.f2, ..., c.fn
)
```

The columns returned by the above query are the same as the ones returned for the analogous query for inferring single column relationships. This allows the probability for multi column table relationships to be computed in exactly the same manner as described for the single column table relationships. For testing whether all the columns in unmatched child rows are sentinel values, the following expression may be added to the select column list of the outermost SELECT in the above query:

```
COUNT(CASE
    WHEN no_of_matches = 0
        AND (c.f1 IS NULL OR c.f1 = <sentinel value for c.f1>)
        ... AND ...
        AND (c.fn IS NULL OR c.fn = <sentinel value for c.fn>)
    THEN 1
    ELSE NULL
END) AS unmatched_sentinel_tuples
```

If unmatched_sentinel_tuples=distinct_child_values−distinct_parent_values, all unmatched rows have only sentinel values in all referencing columns and hence the probability for the inference may be boosted by a multiplier analogous to the manner in which this is done for single column relationships.

The problem of computational feasibility is even more of a consideration for multi column relationships than for single column relationships since the number of all multi column combinations is much larger than the set of all single columns. Thus before querying the data, the following checks are made as follows:
a. If F=(f1, f2, . . . , fn) has been explicitly defined as a foreign key that references U=(u1, u2, . . . un), the test is not performed.
b. Only one-to-many or one-to-one relationships are tested for. Thus U must be a unique key for the test to be performed.
c. All corresponding columns in F and U must have compatible domains. Thus, if column fn is an INTEGER column and column un is a VARCHAR column, the test is not performed.
d. For each column fn in F that corresponds to column un in U, a ratio is obtained by dividing the cardinality of the implied domain set of un by the cardinality of the implied domain set of fn. The minimum of the set of ratios obtained is compared to a configurable threshold. If the configured threshold is higher, the test is not performed.
e. For each column fn in F that is a VARCHAR column with a corresponding column un in U, if the range of the length of fn does not lie within the range of the length of un, the test is not performed. This test is skipped if non-rigorous relationships need to be included in the inference.
f. For each column fn in F with a corresponding column un in U, the range of fn is compared to the range of un. If the range of fn does not lie within the range of un, the test is not performed. This test is skipped if non-rigorous relationships need to be included in the inference.
g. Optionally, the names of all corresponding columns in F and U are compared and the test may not be performed if the names are not similar.
h. Optionally, F may be tested if and only if it is known to be a potential key as identified in one of the previous steps. If not, the test need not be performed.
i. If the criteria listed above do not imply that the test should be skipped, the test is made and a probability computed as described above. If the computed probability is below a threshold, the inference is ignored. Otherwise the inference is stored in the metadata repository along with the associated probability.

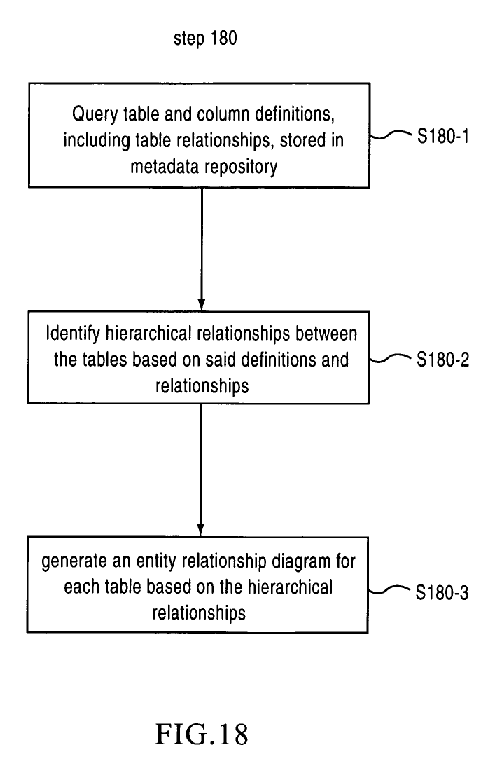

In step 180, a conceptual directed graph of the data model is formed using explicit and implied inferences. Exemplary sub-flows for this step are shown in FIG. 18.

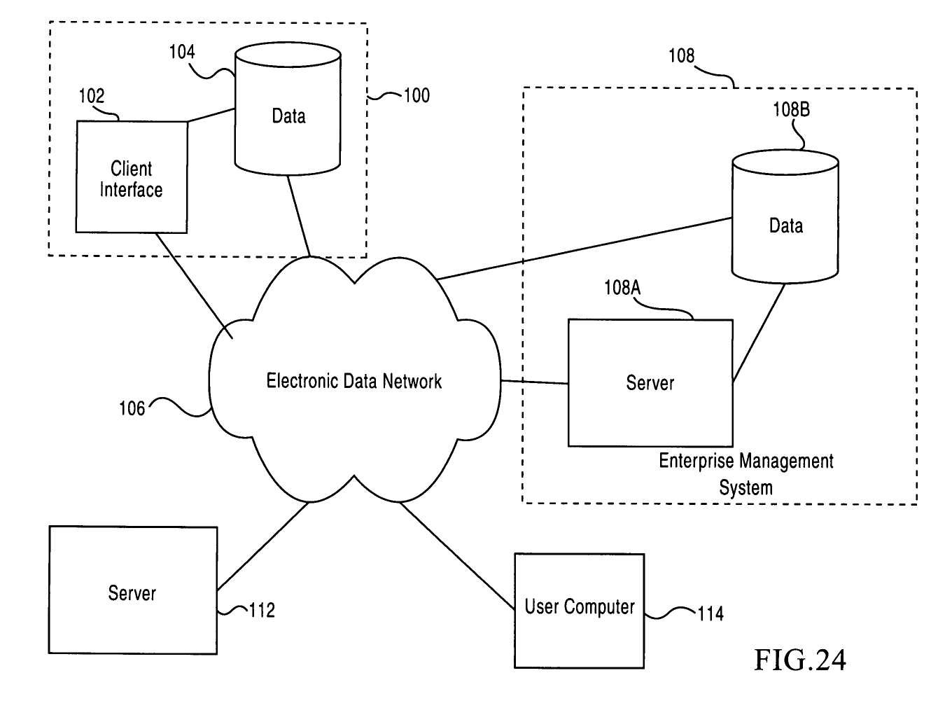

Table and column data is selected from the repository (S180-1). The table and column data is used to identify hierarchical relationships between the tables (S180-2). For example, parent-child relationships can be used to identify the hierarchical relationships. An entity relationship diagram (ERD) or the like can be constructed from the relationships (S180-3). For example, in FIG. 23, the customer table, the order table, the product table and the order item constitute the nodes in the graph. The implied and explicit relationships between the tables constitute the directed edges. Such a graph can be useful to visualize the enterprise data model.

In step 190, final probabilities are computed for all implied inferences. It is noted that all inferences in the prior steps are based on the current relational state. If the relational state changes, some of the inferences may no longer be valid. Unlike explicitly defined elements of the data model, there is no absolute certainty that assertions inferred from the current relational state will apply to all future relational states. If the current relational state was reasonably mature, a high degree of probability could be assumed for such inferences. However, if the current relational state was empty, all tables would be empty and no meaningful inference would be possible.

To compute the final probability for implied inferences, a table is assigned a probability indicating to what extent the current data in the table is representative of the expected data in the table. For example, if a table is expected to contain at most a million rows and the table contains a million or more rows, the probability assigned to such a table may be relatively high. At the same, if it contains only 1000 rows, then the probability that the data in the table is representative of a future relational state is relatively low.

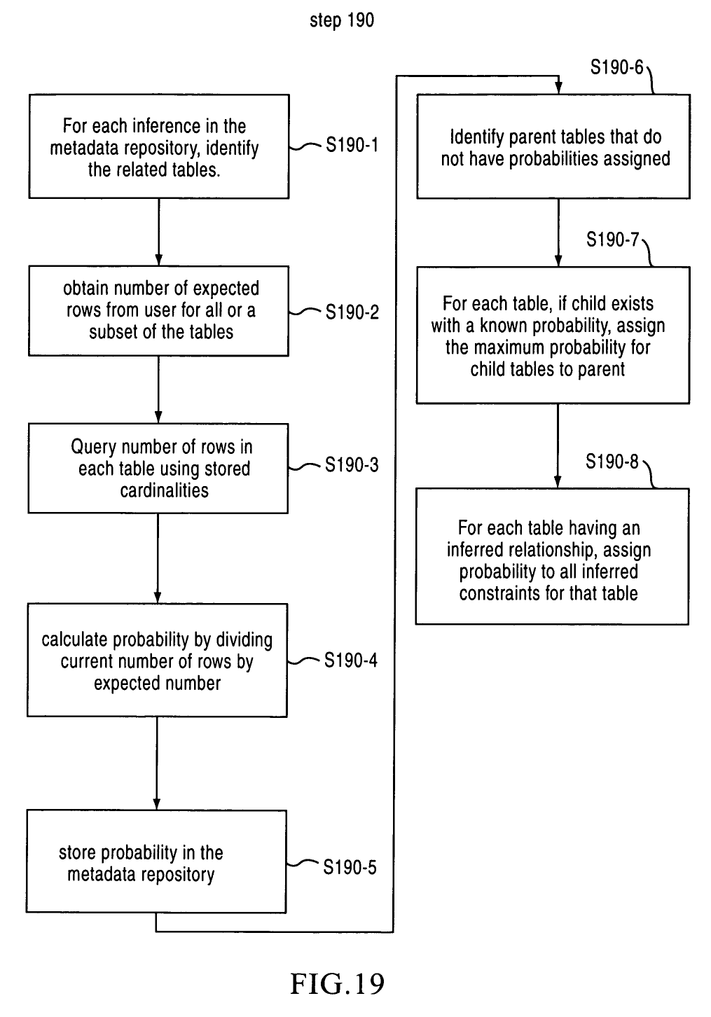

Exemplary sub-flows for this step are shown in FIG. 19.

First, for each inferred constraint in the metadata repository, the associated tables are identified (S190-1). As used herein the phrase “inferred constraint” means any constraint inferred from the method of the present invention of examining the actual data in the data source. To compute probabilities for each inference, either a probability or the number of expected rows in a set or subset of tables in step 20 is obtained (S190-2). This may be in the form of user input and/or some input file. If the information provided is the expected number of rows in the table, the probability for that table could be computed as MIN (<cardinality of the table obtained in step 130 (S190-3)>/<expected rows>, 1.0) (S1904). To estimate a similar probability for tables that do not have a probability specified explicitly, the following steps are performed on the graph of the data model described in step 180:
a. Each node in the graph constructed in step 180 is visited. If the probability of the node is not known or known only provisionally, then the probability associated with each immediate child node is checked (S190-6). The maximum probability associated with the immediate child node is used as a provisional probability for the node (S190-7).
b. The previous step is repeated until there are no new provisional probabilities encountered or no provisional probabilities are reassigned in the previous step.
c. Once the above state is reached, if there are any nodes with no associated probability but are involved in any sort of implied inference, the user may be prompted for additional input. If the user provides additional input, all provisional probabilities are removed and recomputed by repeating all of the above steps.
d. If there are still some nodes with no associated probability but involved in an implied inference, a certain default value may be assigned to each such node based on a user-definable function.

After the above steps, each node that is part of an implied inference has a certain probability associated with it (S190-8). At this point, the probability of each implied inference is computed. For inferred NOT NULL and unique key constraints, the probability is computed as the probability associated with the single table involving the constraint. For inferred foreign key constraints, the probability is computed as the product of the probability associated with the inference itself and the probability associated with the child table.

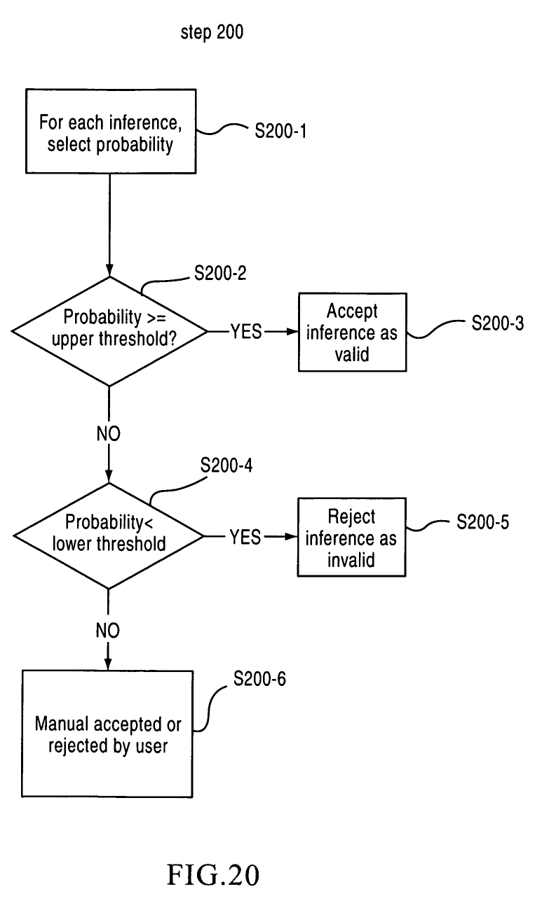

In step 200, the implied inferences may be accepted or discarded based on certain criteria, which may be preset or may include user input. Exemplary sub-flows for this step are shown in FIG. 20.

First, the calculated probability can be selected from the repository (S200-1). Next, the probability can be compared to a threshold (S200-2). As example, threshold h and l may be configured where 1>=h>=l>=0. All inferences with probability>=h are automatically accepted (S200-3). All inferences with probability<l are automatically discarded (S200-5). All inferences with probability<h but >=l are presented to the user in ascending order of probability (S200-6). The user may then accept as valid or discard as invalid some or all of these inferences. By accepting, it is meant that the inferences are confirmed to be valid and accurate and the metadata repository can be made to reflect when an inference is accepted as valid or rejected as invalid. For example, data records can be marked and/or rejected inferences can be deleted.

One skilled in the art will understand that the above steps need not be executed in exactly the same order. One skilled in the art will further understand that certain steps may be run repeatedly and other steps may be skipped altogether. Further, some steps may be replaced with equivalent or similar processes.

The enterprise data model and metadata information derived from the above steps may be persisted to some form of computer storage (e.g., the metadata repository). This allows it to be referenced or updated on an ongoing basis. New data sources may be added to the enterprise data model after the initial model has been constructed, which will result in new elements being added to the model. Data sources already included in the enterprise data model may be reanalyzed. In such a case, certain existing elements of the model may change in response to analysis of new elements.

The “metadata repository” itself can be the output. In other words, each step of the analysis generates data into the repository, which is preferably a database. The repository could also be in the form of a relational database, object-oriented database or text/XML files, and could be stored in any format.

At any point in the process, the repository can be exported or otherwise output to a form suitable for use with BI systems. The repository itself can be tailored to comply with the input requirements of a BI system or an API can be used to convert data from the repository into the proper form for input into a BI system.

Exemplary repository output is illustrated in S120-3 with reference to step 120. In simple terms, step 120 determines the count of distinct or NOT NULL values in columns along with the number of rows in the table itself. For example, assume that the data source has a single table called Employee with 4 columns called Employee_id, Employee_name, Department_id and Salary. The metadata could be stored in a relational database in the following tables:

TABLE metadata_table
(table_id INT NOT NULL PRIMARY KEY,
table_name VARCHAR(255) NOT NULL,
row_count INT NOT NULL)
TABLE metadata_column (
column_id INT NOT NULL PRIMARY KEY,
table_id INT NOT NULL REFERENCES metadata_table (table_id),
column_name VARCHAR(255) NOT NULL,
count_of_non_null_values INT NOT NULL,
count_of_distinct_values INT NOT NULL
)

In the example of an employee table having 1000 rows, all Employee_ids and Employee_names are unique, there are 10 distinct Departments, only 900 employees have been assigned to a department, and there are 50 distinct salaries and everybody gets a salary(!), the analysis would populate the above tables as follows:

metadata_table (table_id, table_name, row_count) = (
(1, ‘employee’, 1000)
)
metadata_column (table_id, table_name, column_name,
count_of_non_null_values, count_of_distinct_values) = (
(1, 1, ‘employee_id’, 1000, 1000),
(2, 1, ‘employee_name’, 1000, 1000),
(3, 1, ‘department_id’, 900, 10),
(4, 1, ‘salary’, 1000, 50),
)

Alternatively, metadata could be stored in an XML document as follows:

```
<TABLE name=“employee” row_count=“1000”>
    <COL name=“employee_id” non_null_values=“1000”
    distinct_values=“1000”>
    <COL name=“employee_name” non_null_values=“1000”
    distinct_values=“1000”>
    <COL name=“department_id” non_null_values=“900”
    distinct_values=“10”>
    <COL name=“salary” non_null_values=“1000”
    distinct_values=“50”>
</TABLE>
```

According to this example, the same data (output from the analysis) can be stored in 2 different formats. However, one skilled in the art will understand that the data could be stored in many other formats and also could be easily converted from one format to another.

According to embodiments of the present invention, some or all of the above-described method steps of the invention may be performed automatically or with the assistance of operator input. Further, the invention may comprise means for performing one or more of the above-described functions or steps, including, but not limited to, appropriate computer hardware and software configured to access disparate data sources, perform the analysis and generate metadata as described in the above-processes with reference to FIG. 1, or equivalent structures.

One skilled in the art will readily understand that numerous commercially available hardware processors and operating systems may be used to implement the method of the present invention. Program units (including, e.g., a set of APIs or similar interfaces) may be provided to expose elements of the enterprise data model or perform certain operations described above programmatically. Further, an operator control board or graphical user interface (GUI) can be provided for user input and control, or computer programs that implement any of the above-steps could be executed from a command line of a computer system connected with the enterprise management system being analyzed by the present invention. One skilled in the art will understand that a combination of the above could be used to implement the present invention.

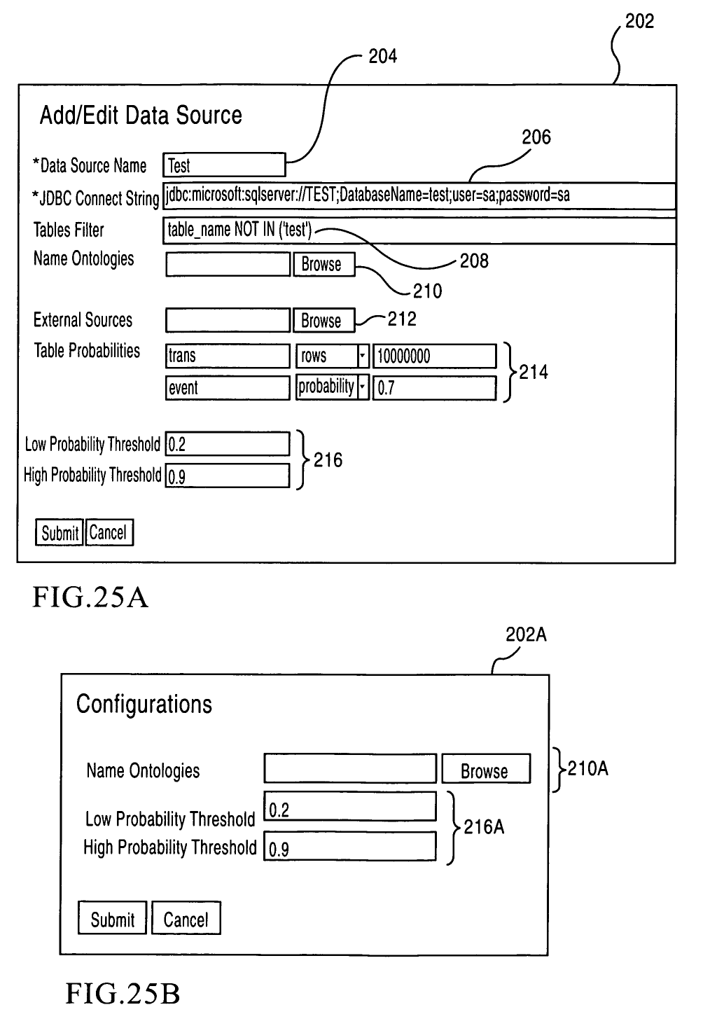

FIG. 24 is a block diagram of a system 100 for generating metadata according to an embodiment of the present invention. System 100 includes a client interface 102 and a database or data storage device 104 for maintaining the metadata repository.

System 100 is shown in communication with an enterprise management system 108 including one or more servers 108A and one or more data sources 108B. System 100 can connect to, and communicate with, the enterprise management system 108 over an electronic data network 106 as shown, or the system can be directly connected to the enterprise management system. Examples of suitable electronic data networks include, but are not limited to, local area networks (LAN), wide area networks (WAN), and distributed networks such as the Internet. It will also be appreciated that the system can be connected to multiple data sources via a combination of direct and networked connections. The system 100 is configured to execute a process for generating metadata, such as the one shown and described above with reference to FIG. 1. Accordingly, the client interface 102 is preferably configured to support an appropriate GUI interface that allows control and input into the process and to execute instructions, such as software processes or program units, for performing the steps for generating metadata. Specifically, client interface 102 may include a processor and memory, storing instructions executable by the processor to generate metadata according to the present invention. Further, client interface 102 should be configured to connect to and communicate with components of the enterprise management system 108, such as any server 108A and data sources (e.g., databases) 108B.

As already described above, information useful for generating robust metadata, such as SQL code, reports, spread sheets, and other informative documents may be found on other computer systems or in other network locations, such as on network servers 112 and user desktops 114.

According to a preferred embodiment, system 100 is connected to one or more computer systems running BI tools. The BI tools may operate on any one of the enterprise management system 108, the server 112, or the user computer 114, or some combination of the foregoing.

According to embodiments of the present invention, the system can be configured to accept user input as follows:

Data sources to analyze: the system may be configured to allow a user to specify any number of data sources to analyze. The following information is preferred for each data source:
a. A name for the data source
b. A JDBC connect string (JDBC is an API that standardizes SQL database access for Java programs).
   Note that the current implementation of the system is Java based. If the current system were instead based on some technology such as .NET, a connect string suitable for that particular technology may be provided. For .NET, it would be ADO.NET connection string. Similarly, it could be an ODBC connect string for other platforms such as C/C++ on Windows. Alternately, native libraries for databases such as OCI for Oracle may be used. The specific library used does not fundamentally alter the principles used throughout the invention.

Tables to analyze in each data source: By default, all tables in each data source should be analyzed. However, the user may specify a filter and/or select through a GUI only a subset of tables to be included in the analysis. Each table in a given data source may be identified by the 3-ary (ternary) tuple with the attributes (catalog_name, schema_name, table_name). The user may define a filter in the form of SQL to filter the set of tables. Thus a user may specify a filter such as
table_name LIKE ‘acct_%’ OR table_name LIKE ‘inv_%’
   to restrict the analysis to accounting and inventory table presuming a naming convention that prefixes all accounting related tables with acct_ and all inventory related tables with inv_.

In addition to such a filter, the user may also explicitly select/deselect tables to select/deselect through a GUI.

Name ontologies to use for each data source: The system uses name ontologies or rules to generate alternate column names. These may be specified for each data source.

Sentinel Values: User may specify the sentinel values for various data types. These values are used while inferring non-rigorous table relationships.

Options for inferring table relationships: User may specify various options to be used while inferring table relationships. Different options may be defined based on the number of columns in the key. Various sub-options allowed are:
1. Probability Threshold: Used as the low threshold for rejecting non-rigorous relationships. A value of 1.0 implies only rigorous relationships should be considered.
2. Booster for sentinel only mismatches: Probability multiplier to be used to boost probability computed for an inferred relationship if all unmatched child rows contain only sentinel or NULL values in the referencing columns.
3. Requires Similar Names: Controls whether data should be inspected for inferring relationships only if the corresponding columns referencing and referenced columns have similar names.
4. Requires Potential Keys: Controls whether data should be inspected for inferring relationships only if the set of referencing columns is identified as a potential key.

Queries from external data sources: The system can be configured to obtain all procedural code from the relational catalogs. Additionally, the system allows the user to provide an additional set of queries that can be used to aid in the analysis. This is done by providing a list of files containing such external queries for each data source.

The system should be configured to accept data regarding expected rows in a table or probability of the data in a table being representative of a mature relational state: These are used to assign probabilities (level of confidence) to constraints inferred by the system.

Probability thresholds for inferred constraints: 2 probabilities ‘l’ and ‘h’ can preferably be specified for each data source. ‘l’ specifies a probability threshold such that if the computed probability for an inferred constraints is below ‘l’, the inference is automatically rejected. ‘h’ specifies a probability threshold such that if the computed probability for an inferred constraints is same as or above ‘h’, the inference is automatically accepted.

User acceptance of inferred constraints: For inferred constraints whose computed probability is >=‘l’ and <‘h’, the system can be configured to prompt the user to accept/reject the inference.

System defaults: The system can be configured to allow the user to specify default probability threshold and name ontologies to be associated with data sources. The data source level then either override the probability threshold or extend the name ontologies.

The present invention can be arranged in many known architectures. Accordingly, the system of the present invention can be implemented in a centralized or distributed architecture. Programs implementing steps of the process can be executed from a command line prompt, such as on client interface 102, using inputs via XML files or the like. For example, the following illustrates a sample XML input file along with its corresponding DTD:

```
  <?xml version=“1.0” encoding=“UTF-8” ?>
  <!DOCTYPE Interface (View Source for full doctype...)>
- <Interface>
- <DefaultSettings>
- <NameOntologies>
  <NameOntology>z:\test\test1.ontology</NameOntology>
  <NameOntology>z:\test\test2.ontology</NameOntology>
  </NameOntologies>
  <SentinelValue DataType=“Numeric” Value=“0” />
  <SentinelValue DataType=“Character” Value=“0” />
  <OptionsForRelationshipInference
        ApplyToColumnSetNotExceeding=“1”
        BoosterForSentinelOnlyMismatches=“1.2”
        ProbabilityThreshold=“0.9”
  />
  <OptionsForRelationshipInference
        ApplyToColumnSetNotExceeding=“n”
        BoosterForSentinelOnlyMismatches=“1.2”
        ProbabilityThreshold=“0.9”
        RequiresSimilarNames=“Yes”
        RequiresPotentialKeys=“Yes”
  />
- <ProbabilityThresholds>
  <LowThreshold>0.2</LowThreshold>
  <HighThreshold>0.9</HighThreshold>
  </ProbabilityThresholds>
  </DefaultSettings>
- <DataSources>
- <DataSource>
  <DataSourceName>Test</DataSourceName>
<ConnectString>jdbc:microsoft:sqlserver://TEST;DatabaseName=test;user=sa;
password=sa</ConnectString>
  <TablesFilter>table_name NOT IN (‘test’)</TablesFilter>
- <NameOntologies>
  <NameOntology>z:\test\test3.ontology</NameOntology>
  </NameOntologies>
  <OptionsForRelationshipInference
        ApplyToColumnSetNotExceeding=“1”
        ProbabilityThreshold=“0.8”
  />
- <ExternalSources>
  <ExternalSource>z:\test\external\*.*</ExternalSource>
  </ExternalSources>
- <TableProbabilities>
- <TableProbability>
  <Table>trans</Table>
  <ExpectedRows>10000000</ExpectedRows>
  </TableProbability>
- <TableProbability>
  <Table>event</Table>
  <Probability>0.7</Probability>
  </TableProbability>
  </TableProbabilities>
  </DataSource>
  </DataSources>
  </Interface>
<?xml version=“1.0” encoding=“UTF-8”?>
<!ELEMENT Interface (DefaultSettings?, DataSources,
DataSourcesRequiringProbabilitiesInput?, InferredConstraints?)>
<!ELEMENT DefaultSettings (NameOntologies?, SentinelValue*,
OptionsForRelationshipInference*, ProbabilityThresholds?)>
<!ELEMENT NameOntologies (NameOntology+)>
<!ELEMENT NameOntology (#PCDATA)>
<!ELEMENT SentinelValue EMPTY>
<!ATTLIST SentinelValue
        DataType CDATA #REQUIRED
        Value CDATA #REQUIRED
>
<!ELEMENT OptionsForRelationshipInference EMPTY>
<!ATTLIST OptionsForRelationshipInference
CDATA #REQUIRED
CDATA #IMPLIED
CDATA #IMPLIED
(Yes|No) #IMPLIED
(Yes|No) #IMPLIED
>
<!ELEMENT ProbabilityThresholds (LowThreshold, HighThreshold)>
<!ELEMENT LowThreshold (#PCDATA)>
<!ELEMENT HighThreshold (#PCDATA)>
<!ELEMENT DataSources (DataSource+)>
<!ELEMENT DataSource (DataSourceName, ConnectString, TablesFilter?,
NameOntologies?, SentinelValue*, OptionsForRelationshipInference*,
ExternalSources?, TableProbabilities?, ProbabilityThresholds?)>
<!ELEMENT DataSourceName (#PCDATA)>
<!ELEMENT ConnectString (#PCDATA)>
<!ELEMENT TablesFilter (#PCDATA)>
<!ELEMENT ExternalSources (ExternalSource+)>
<!ELEMENT ExternalSource (#PCDATA)>
<!ELEMENT TableProbabilities (TableProbability+)>
<!ELEMENT TableProbability (Table, (ExpectedRows | Probability))>
<!ELEMENT Table (#PCDATA)>
<!ATTLIST Table
        Catalog CDATA #IMPLIED
        Schema CDATA #IMPLIED
>
<!ELEMENT ExpectedRows (#PCDATA)>
<!ELEMENT Probability (#PCDATA)>
<!ELEMENT DataSourcesRequiringProbabilitiesInput
(DataSourceRequiringProbabilitiesInput+)>
<!ELEMENT DataSourceRequiringProbabilitiesInput (DataSourceName, Table+)>
<!ELEMENT InferredConstraints (InferredConstraint+)>
<!ELEMENT InferredConstraint (#PCDATA)>
<!ATTLIST InferredConstraint
        ComputedProbabilty CDATA #REQUIRED
        Acceptance
(AutoAccepted|AutoRejected|NeedUserInput|AcceptedByUser|RejectedByUser|Invalidated
) #REQUIRED
>
```

Accordingly, the above program can be invoked from the command line by the command:

<system-executable name><Input XML file><Output XML file>.

The output of the system (e.g., inferred restraints, etc.) can be in XML format as well. In a preferred embodiment, the user may modify the output file and provide the modified output file as input to re-perform the analysis.

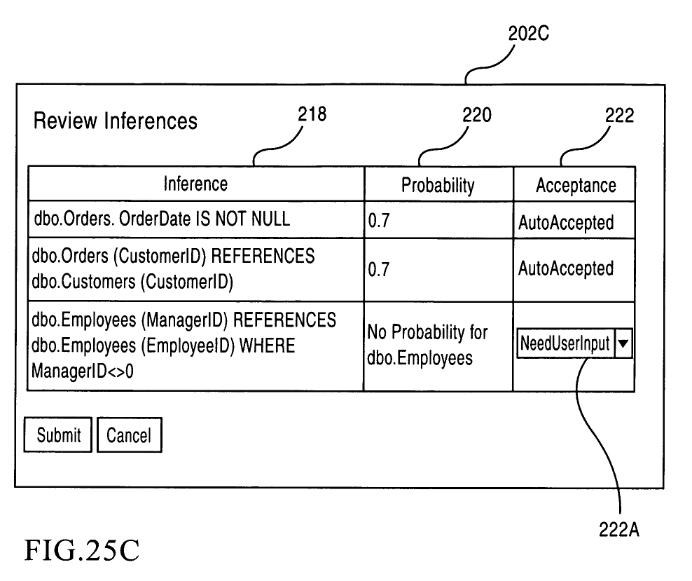

A simple, exemplary user interface is shown in FIGS. 25A-C. As shown, an input screen 202 can be utilized for inputting data source information, such as the Data Source Name 204, and JDBC Connect String 206. Additional information that can be entered via screen 202 to assist with analysis include table filters 208 for restricting which tables to analyze, name ontologies 210, external sources or files 212, table probabilities 214 and probability thresholds 216. As shown in FIG. 25B, probability thresholds 216A can be given for each name ontology 210A. As shown in FIG. 25C, a screen 202C for reviewing and accepting inferences can be provided as well. The screen 202C is depicted as showing inferences in a first column 218, probabilities corresponding to the inferences in a second column 220, and an indication whether or not the inference has been accepted in a third column 222. Also shown in the third column is a drop down menu 222A allowing the user to manually accept or reject an inference. One skilled in the art will recognize many well known and conventional tools for designing and implementing such interfaces, such as using MICROSOFT ACCESS, VISUAL BASIC, HTML, XML, JAVA or JAVA SCRIPT, .NET CONTROLS, etc., and the system of the present invention is not limited to any specific architecture, computing arrangement or software language.

Other methods to provide user input and control are contemplated as well. For example, the input could be provided via simple text files with, for example, windows.ini or the like, or could simply be passed as command line arguments. Similarly, a GUI may be web-based or windows-based client, or other known interface technology.

Thus it would be possible to perform a reanalysis periodically by scheduling invocation of such an API to reanalyze all existing database interfaces.

As a result of the above configurations, universally applicable computer software can be provided that creates metadata from any group of enterprise databases by interrogating and reverse engineering the databases. The present invention infers specific information and rules about the retrieved data that are then used to streamline and accelerate the output of the enterprise software. Optionally, the invention uses predefined, as well as user-definable specifications, to aid in the inference. The present invention also provides a method of creating such inference that may be applied to any relational or relational-like database systems that expose their metadata through some means and provides a SQL-like language to query the data itself.

The software of the present invention creates rules that allow quick implementations and iterations that produce output that becomes business knowledge for critical decision-making by the user of the software product. The present invention is effective with any COTS (commercial off-the-shelf) enterprise software used by corporations today. Whether the application is CRM (customer relation management), accounting, specialized inventory or any other data intensive analysis, the present invention enables correct results quicker, better and cheaper than competitive software.

Thus, according to the above-described embodiments, systems and methods are provided for analyzing data sources to automatically infer constraints and relationships to generate metadata that is particularly useful with business intelligence (BI) systems.

One non-limiting advantage of the present invention is that the systems and methods make possible the reverse engineering of the most complicated enterprise management systems, which may include disparate data sources, and production of a comprehensive and robust metadata repository for use with BI platforms. Until the present invention, no other system existed that performed as in-depth analysis nor did one exist that could analyze disparate data sources like the present invention.

One feature of the present invention includes a system for “automatic” inference of NOT NULL, unique and referential integrity constraints. Such inferences serve primarily the following two purposes:
In the form of referential integrity constraints, the inference provides “join paths” or relationships between two tables. This knowledge is critical for the query engine to automatically generate SQL.
Any constraint, whether inferred or explicit, provides information to the query engine for query optimization. For example, if a certain column is known to only have values from a given set, any condition that checks for that column to contain a value not in that set can be evaluated to false even without querying any data.

According to embodiments of the present invention, a number of techniques can be employed to derive information from data sources, including, but not limited to, data catalog queries, interrogation of data, program analysis, and analysis of other queries.

For example, queries can be run against the source database catalog for constraints. Data can be interrogated to reverse engineer various kinds of constraints. The primary challenge with this technique is the computational infeasibility of trying out all permutations and computations. This will be addressed by the algorithm of the present invention that reduces the search space by looking at a host of other information such as column naming conventions, data distribution, and other attributes. Analysis of existing procedure, SQL and other common programming languages can be performed to aid in the inference of data relationships. Analysis of queries actually executed against the database over a period of time can also provide additional information such as potential keys that can aid in this inference.

As will be understood by one skilled in the art, the degree of sophistication of the reverse engineering systems and methods determines the level of manual effort required to populate the metadata repository. That is, although it is preferred that the present invention perform all steps automatically, it is realized that extremely large and/or complex systems often present unique obstacles that require some level of manual analysis or customization. If, however, all data sources were accessible from a single point, theoretically, the present invention could be implemented in a plug-and-play embodiment.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

We claim:

1. A method for generating metadata relating to at least one data source, the at least one data source including one or more tables, each table having one or more columns, said method comprising steps of:
inferring constraints existing on at least one of the tables and columns in the data source based on data in the tables and columns; and
generating metadata including information on the inferred constraints.

2. The method of claim 1 wherein said inferring step further includes generating at least one query statement and inferring constraints based upon a result of the at least one query statement.

3. The method of claim 1 further comprising a step of storing the metadata in a metadata repository.

4. The method of claim 1 wherein said inferring step further includes identifying at least one query statement for accessing the one or more tables and inferring constraints based on the at least one identified query statement.

5. The method of claim 4 wherein said inferring step further includes normalizing the at least one identified query statement and inferring constraints based on the at least one normalized query statement.

6. The method of claim 5 further comprising a step of identifying potential keys for each of the tables based on at least one of a normalized query statement, an alias, and an index.

7. The method of claim 6 further comprising a step of storing metadata on the potential keys in a metadata repository.

8. The method of claim 3 further comprising a step of generating one or more aliases for each column based on at least one of ontologies and normalized query statements for querying data from the at least one data source; and wherein said storing step further includes storing the one or more aliases.

9. The method of claim 1 further comprising a step of calculating a cardinality of each of the tables and columns in the at least one data source; and
wherein said inferring step further includes inferring constraints based on the calculated cardinalities.

10. The method of claim 1, wherein the constraints include at least one of NOT NULL constraints, unique key constraints, and referential integrity constraints.

11. The method of claim 4, wherein the constraints include at least one of NOT NULL constraints, unique key constraints, and referential integrity constraints.

12. The method of claim 1, further comprising:
a step of, for each inferred constraint, calculating a probability that the inference is valid;
a step of, for each inferred constraint, marking the constraint as valid in the metadata repository when the corresponding probability equals or exceeds an upper threshold; and
a step of, for each inferred constraint, marking the constraint as invalid in the metadata repository when the corresponding probability is less than a lower threshold.

13. A system for generating metadata for one or more data sources, said system comprising:
one or more computer program units configured to access one or more data sources and to generate metadata by inferring constraints based on data in tables and columns of the one or more data sources.

14. The system of claim 13 wherein said one or more computer program units are configured to generate at least one query statement and infer constraints based upon results of the at least one query statement.

15. The system of claim 13 further comprising a metadata repository; wherein said one or more computer program units are further configured to store generated metadata in said metadata repository.

16. The system of claim 13 wherein said one or more computer program units are further configured to identify at least one query statement for accessing the identified tables and to infer constraints based on the at least one identified query statement.

17. The system of claim 16 wherein said one or more computer program units are further configured to normalize the at least one identified query statement and to infer constraints based on the at least one normalized query statement.

18. The system of claim 13 wherein said one or more computer program units are further configured to identify one or more aliases for tables and columns in each data source based on ontologies.

19. The system of claim 13 wherein said one or more computer program units are further configured to obtain aliases of tables and columns in each data source by parsing the name of said tables and columns into separate words and generating aliases by applying ontologies to the separate words.

20. The system of claim 13 wherein said one or more computer program units are further configured to confirm validity of inferred constraints from normalized structured query language (SQL) code used to query data from said data source.

21. The system of claim 17 wherein said one or more computer program units are further configured to identify potential keys for one or more of the tables based on at least one of the normalized query statements, indexes and aliases.

22. The system of claim 13 further comprising:
a client interface for inputting data relating to said one or more data sources, and wherein said one or more computer program units are further configured to analyze each data source to generate metadata further based on data inputted via the client interface.

23. The system of claim 13 wherein said metadata repository includes a database, and wherein said one or more computer program units are further configured to access said database to insert, modify, delete and query metadata stored therein.

24. The system of claim 15 wherein said one or more computer program units are further configured to extract table and column information from SQL code, and to store said extracted table and column information in said metadata repository.

25. The system of claim 13 wherein said one or more computer program units further include:
a computer program unit for generating SQL query code for determining cardinalities and data ranges for the tables and columns; and
a computer program unit for identifying potential relationships between the tables based on said cardinalities and data ranges.

26. The system of claim 13 wherein the constraints comprise at least one of NOT NULL constraints, unique key constraints, and referential integrity constraints.

27. The system of claim 17 wherein the constraints comprise at least one of NOT NULL constraints, unique key constraints, and referential integrity constraints.

28. The system of claim 15 wherein said one or more program units are configured to calculate a probability that an inference is valid, mark the constraint as valid in the metadata repository when the corresponding probability equals or exceeds an upper threshold, and mark the constraint as invalid in the metadata repository when the corresponding probability is less than a lower threshold.

29. A computer-readable medium storing computer-executable instructions for generating metadata relating to at least one data source having a one or more of tables, each table having one or more columns, by performing operations comprising:
inferring constraints existing on at least one of the tables and columns in the data source based on data in the tables and columns; and
generating metadata including information on the inferred constraints.

30. The computer-readable medium of claim 29 wherein said inferring operation further includes generating at least one query statement and inferring constraints based upon results of the at least one query statement.

31. The computer-readable medium of claim 29 comprising further computer-executable instructions for storing the metadata in a metadata repository.

32. The computer-readable medium of claim 29 comprising further computer-executable instructions for identifying at least one query statement for accessing the one or more of tables and inferring constraints based on the at least one identified query statement.

33. The computer-readable medium of claim 32 comprising further computer-executable instructions for normalizing the at least one identified query statement and inferring constraints based on the at least one normalized query statement.

34. The computer-readable medium of claim 33 comprising further computer-executable instructions for generating one or more aliases for each of the columns based on at least one of ontologies and normalized query statements for querying data from the database and storing the one or more aliases.

35. The computer-readable medium of claim 34 comprising further computer-executable instructions for identifying potential keys for each of the tables based on at least one of the one or more normalized query statements, indices and the one or more aliases.

36. The computer-readable medium of claim 35 comprising further computer-executable instructions for storing metadata on the potential keys in a metadata repository.

37. The computer-readable medium of claim 29 comprising further computer-executable instructions for calculating a cardinality of each of the tables and columns in the data source and
inferring constraints based on the calculated cardinalities.

38. The computer-readable medium of claim 29 wherein the constraints comprise at least one of NOT NULL constraints, unique key constraints, and referential integrity constraints.

39. The computer-readable medium of claim 33 wherein the constraints comprise at least one of NOT NULL constraints, unique key constraints, and referential integrity constraints.

40. The computer-readable medium of claim 31 comprising further computer-executable instructions for calculating a probability that each inferred constraint is valid;
marking each inferred constraint as valid in the metadata repository when the corresponding probability equals or exceeds an upper threshold; and
marking each inferred constraint as invalid in the metadata repository when the corresponding probability is less than a lower threshold.

41. A method for generating a metadata repository comprising metadata relating to one or more data sources, said method comprising steps of:
A. identifying a set of data sources to be analyzed from said data sources and connection information corresponding to each identified data source, and storing the identification of each data source and the corresponding connection information in a metadata repository;
B. for each database instance identified in step A, determining one or more tables of interest from each database instance along with column names for each table and storing the identified tables of interest along with the column names in the metadata repository;
C. for each table and column obtained in step B, determining a list of explicitly defined constraints for each table, and storing the list of explicitly defined constraints in the metadata repository;
D. converting column names obtained in step B to a user-friendly form by applying a function to each column name to generate aliases and storing the aliases in the metadata repository;
E. determining indices on each of the tables obtained in step B;
F. identifying view definitions including corresponding query statements for each of the data sources;
G. determining procedural code including corresponding query statements for each of the data sources;
H. obtaining a list of query statements that have been executed against each of the data sources;
I. normalizing each query statement identified in steps F through H to extract table and column information, and storing the table and column information in the metadata repository;
J. identifying potential keys for each table identified in step C based on the table and column information of at least one of steps E through I and storing the potential keys in the metadata repository; and
K. identifying sets of columns that are not known to be potential keys that have similar names to potential keys identified in step J and storing the sets of columns as additional potential keys in the metadata repository.
